(19) United States
(12) Patent Application Publication
(10) Pub. No.: US 2026/0265416 A1
(43) Pub. Date: Sep. 10, 2026

(54) POLYMER MODIFIED NANOFIBER COMPOSITES

(71) Applicant: University of Maine System Board of Trustees, Orono, ME (US)

(72) Inventors: Douglas J. Gardner, Eddington, ME (US); William M. Gramlich, Glenburn, ME (US); Peter V. Kelly, Minneapolis, MN (US)

(73) Assignee: University of Maine System Board of Trustees, Orono, ME (US)

(21) Appl. No.: 19/163,491

(22) PCT Filed: Mar. 22, 2024
(86) PCT No.: PCT/US2024/021115

§ 371 Date: Sep. 9, 2025

Related U.S. Application Data
(60) Provisional application No. 63/454,349, filed on Mar. 24, 2023.
(60) Provisional application No. 63/599,967, filed on Nov. 16, 2023.

(51) Int. Cl. C08B 3/00; B29B 15/12; B29K 201/00; B33Y 70/10; C08B 1/00

(52) U.S. Cl. CPC C08B 3/00; B29B 15/122; B33Y 70/10; C08B 1/003; B29K 2201/00

(57) ABSTRACT

Provided herein are methods for surface modification of cellulosic material and/or cellulose containing fibers and fibrils. Further, the present disclosure provides compositions produced according to described methods.

### GOVERNMENT FUNDING

This invention was made with government support under contract number DE-AC05-00R22725 (subcontract 4000174848), awarded by the U.S. Department of Energy. The government has certain rights in the invention.

### BACKGROUND

The energy demand to produce cellulose nanofibrils (CNFs) from cellulosic pulp fibers is high. In addition, the cost of cellulosic pulp fibers is substantial as high purity cellulose dissolving pulp is generally used.

### SUMMARY

Cellulosic materials have been used across diverse industrial sectors to fabricate a wide array of cellulose commodities, e.g., fabrics, paper, corrugated fiberboard, and cellulose nanofibrils (CNFs) (see, e.g., Fu Q, Cui C, Meng L, et al (2021) Emerging cellulose-derived materials: a promising platform for the design of flexible wearable sensors toward health and environment monitoring. Mater Chem Front 5:2051-2091; Fatema N, Ceballos R M, Fan C (2022) Modifications of cellulose-based biomaterials for biomedical applications. Front Bioeng Biotechnol 10; and Seddiqi H, Oliaei E, Honarkar H, et al (2021) Cellulose and its derivatives: towards biomedical applications. Cellulose 28:1893-1931). CNFs are obtained by submitting cellulosic pulp fibers to shearing forces until the fiber wall is fibrillated into individual fibrils (see, e.g., Gorur Y C, Reid M S, Montanari C, Larsson P T, Larsson P A, Wågberg L. Advanced Characterization of Self-Fibrillating Cellulose Fibers and Their Use in Tunable Filters. ACS Appl Mater Interfaces. 2021 Jul. 14; 13 (27): 32467-32478). With the rising interest in CNFs in recent years, the mechanical fibrillation procedure involving cellulosic materials has prompted endeavors to improve efficiency and overall productivity (see, e.g., Thakur V, Guleria A, Kumar S, et al (2021) Recent advances in nanocellulose processing, functionalization and applications: a review. Mater Adv 2:1872-1895).

Mechanical fibrillation processes, including homogenization, refining, and grinding, may transform cellulosic pulp fibers into CNFs (see, e.g., Nechyporchuk O, Belgacem M N, Bras J (2016) Production of cellulose nanofibrils: A review of recent advances. Ind Crops Prod 93:2- 25). However, these mechanical fibrillation methodologies often have issues related to high-energy demand, which increases the CNF production cost (see, e.g., Spence K L, Venditti R A, Rojas O J, et al (2011) A comparative study of energy consumption and physical properties of microfibrillated cellulose produced by different processing methods. Cellulose 18:1097-1111). Studies have demonstrated that chemical surface modifications can be used to improve delamination of CNFs from cellulosic pulp fiber (see, e.g., Van Hai L, Zhai L, Kim H C, et al (2018) Cellulose nanofibers isolated by TEMPO-oxidation and aqueous counter collision methods. Carbohydr. Polym. 191:65-70). For example, a negatively charged group, like carboxyl and sulfate, may enhance the electrostatic repulsion between the CNFs. One of the most common methods of carboxylation is using 2,2,6,6-tetramethylpiperidine-1-oxyl radical (TEMPO)-oxidation reaction. This modification was shown to enhance CNF production with thinner fibers and improved properties (see, e.g., Van Hai L, Zhai L, Kim H C, et al (2018) Cellulose nanofibers isolated by TEMPO-oxidation and aqueous counter collision methods. Carbohydr. Polym. 191:65-70). Sulfonation, acetylation, periodate oxidation, and adding phosphorous-containing moieties are other chemical pretreatment techniques used to introduce negatively charged groups on the surface of cellulose fibers and promote the nano-fibrillation process (see, e.g., Copenhaver K, Li K, Wang L, et al (2022) Pretreatment of lignocellulosic feedstocks for cellulose nanofibril production. Cellulose 29:4835-4876).

In accordance with various embodiments, the present disclosure provides an insight that surface modification of cellulosic material (e.g., wood pulp) and/or cellulose containing fibers and fibrils (e.g., CNFs) may address challenges associated with production and use of CNFs. Without wishing to be bound by any particular theory, polymers applied to cellulosic material (e.g., wood pulp) and/or cellulose containing fibers and fibrils (e.g., CNFs) may adjust the hydrophilicity/hydrophobicity balance, disrupt hydrogen bonding, and introduce new functionalities (e.g., promoting effective fibrillation and potentially alter the drying process).

One aspect of the present disclosure provides methods including providing cellulosic material (e.g., wood pulp), modifying at least a portion of the cellulosic material to form a modified cellulosic material comprising an acrylate ester moiety, associating and covalently attaching to the modified cellulosic material a plurality of monomers through a water-borne polymerization at the acrylate ester moiety to form a modified cellulosic-polymer material, and fibrillation of the modified cellulosic-polymer material to form a polymer modified cellulosic material containing fibers and fibrils. In another aspect, the present disclosure provides methods including providing cellulosic material (e.g., wood pulp), modifying at least a portion of the cellulosic material to form a modified cellulosic material comprising an acrylate ester moiety, fibrillation of the modified cellulosic material comprising an acrylate ester moiety to form a modified cellulosic material containing fibers and fibrils, and associating and covalently attaching to the modified cellulosic material containing fibers and fibrils a plurality of monomers through a water-borne polymerization at the acrylate ester moiety to form a polymer modified cellulosic material containing fibers and fibrils. In some embodiments, a variety of compositions are considered to be compatible with methods provided herein. In some embodiments, the cellulosic material is or comprises wood pulp, wheat straw pulp, highly refined flax fiber, agricultural waste, or a combination thereof. In some embodiments, the modified cellulosic-polymer material and/or the modified cellulosic material is in the aqueous suspension during fibrillation. In some embodiments, the fibrillation is mechanical. In some embodiments, the modified cellulosic-polymer material and/or the modified cellulosic material is fibrillated using a supermasscolloider (SMC).

In another aspect, the present disclosure provides methods including providing a cellulose containing fibers and fibrils (e.g., CNFs), modifying at least a portion of the cellulose containing fibers and fibrils in water to form a modified cellulose comprising an acrylate ester moiety, and associating and covalently attaching to the modified cellulose a plurality of monomers through a water-borne polymerization at the acrylate ester moiety to form a polymer modified cellulose material containing fibers and fibrils.

In some embodiments, a cellulosic material (e.g., wood pulp) and/or cellulose containing fibers and fibrils (e.g., CNFs) is in aqueous suspension at the time of initiating the step of modifying the cellulosic material.

In accordance with various embodiments, cellulosic material (e.g., wood pulp) and/or cellulose containing fibers and fibrils (e.g., CNFs) is in a reaction solution of a volume of at least about 100 liters. In some embodiments, a solution is or comprises water. In some embodiments, the solution is maintained at a pH. In some embodiments, a pH is about 6 to 12. In some embodiments, a solution is stirred and/or mixed.

In accordance with various aspects, an acrylate ester moiety may be or comprise a methacrylate ester. In some embodiments, modifying is or comprises associating the cellulosic material with an acrylic anhydride. In some embodiments, associating is or comprises one or more covalent bonding events. In some embodiments, an acrylic anhydride is a methacrylic anhydride. In some embodiments, an acrylic anhydride is not maleic anhydride. In some embodiments, the cellulosic material and the methacrylic anhydride are in the solution at a ratio of at least about 20:1 of methacrylic anhydride moieties:cellobiose moieties and are in the presence of NaOH. In some embodiments, the cellulosic material and the methacrylic anhydride are in the solution at a ratio of at least about 10:1 of methacrylic anhydride moieties:cellobiose moieties and are in the presence of NaOH.

In some embodiments, a monomer is or comprises a radical polymerizable monomer. In some embodiments, a monomer is or comprises an acrylate, an acrylic acid, an acrylamide, a styrene, a diene (e.g., butadiene, isoprene, chloroprene), acrylonitrile, a vinyl ether, or a vinyl acetate. In some embodiments, the acrylate is selected from methyl methacrylate (MMA), butyl methacrylate (BMA), hexyl methacrylate (HMA), 2,2,2-trifluoroethyl methacrylate (TFEM), oligoethylene glycol methyl ether methacrylate (OEGMA), 2-hydroxyethyl methacrylate (HEMA), dimethyl 2-methylenesuccinate (DMI), methyl acrylate (MA), butyl acrylate (BA), hexyl acrylate (HA), and oligoethylene glycol methyl ether acrylate (OEGA). In some embodiments, the acrylic acid is selected from acrylic acid (AA) and methacrylic acid (MAA). In some embodiments, the acrylamide is selected from acrylamide (AM), N-isopropylacrylamide (NIPAM), methacrylamide (MAM), N,N-Dimethylacrylamide (DMAA), and N-[3-(Dimethylamino)propyl]methacrylamide (DMAPMA). In some embodiments, the styrene is an unsubstituted styrene (Sty).

In some embodiments, a modified cellulosic-polymer material, polymer modified cellulosic material containing fibers and fibrils, and/or polymer modified cellulose material containing fibers and fibrils comprises at least one polymer selected from an acrylate ester polymer, an acrylic acid polymer, an acrylamide polymer, a styrene polymer, a diene polymer, vinyl ether polymer, and/or a vinyl acetate polymer. In some embodiments, the acrylate ester polymer is selected from methyl methacrylate polymer (MMA), butyl methacrylate (BMA) polymer, hexyl methacrylate (HMA) polymer, 2,2,2-trifluoroethyl methacrylate (TFEM) polymer, oligoethylene glycol methyl ether methacrylate (OEGMA) polymer, 2-hydroxyethyl methacrylate (HEMA) polymer, dimethyl 2-methylenesuccinate (DMI) polymer, methyl acrylate (MA) polymer, butyl acrylate (BA) polymer, hexyl acrylate (HA) polymer, and oligoethylene glycol methyl ether acrylate (OEGA) polymer. In some embodiments, the acrylic acid polymer is selected from acrylic acid (AA) polymer and methacrylic acid (MAA) polymer. In some embodiments, the acrylamide polymer is selected from acrylamide (AM) polymer, N-isopropylacrylamide (NIPAM) polymer, methacrylamide (MAM) polymer, N,N-Dimethylacrylamide (DMAA) polymer, and N-[3-(Dimethylamino)propyl]methacrylamide (DMAPMA) polymer. In some embodiments, the acrylamide polymer is selected from acrylamide (AM) polymer, N-isopropylacrylamide (NIPAM) polymer, and methacrylamide (MAM) polymer. In some embodiments, the styrene polymer is an unsubstituted styrene (Sty) polymer.

In accordance with various aspects, provided methods further comprises preparing a polymer modified cellulosic material containing fibers and fibrils and/or polymer modified cellulose material containing fibers and fibrils for addition to a matrix polymer. In some embodiments, preparing comprises drying the polymer modified cellulosic material containing fibers and fibrils and/or polymer modified cellulose material containing fibers and fibrils. In some embodiments, drying is or comprises spray drying or oven drying. In some embodiments, a polymer modified cellulosic material containing fibers and fibrils and/or polymer modified cellulose material containing fibers and fibrils is substantially dry at the time of initiating the addition to the matrix polymer.

In some embodiments, a polymer modified cellulosic material containing fibers and fibrils and/or polymer modified cellulose material containing fibers and fibrils is characterized as a reduction in fiber and/or fibril aggregation upon drying as compared to unmodified cellulose containing fibers and fibrils. In some embodiments, a polymer modified cellulosic material containing fibers and fibrils and/or polymer modified cellulose material containing fibers and fibrils is characterized as an increase in specific surface area upon drying as compared to unmodified cellulose containing fibers and fibrils.

In accordance with various aspects, provided methods further comprise forming a composite by associating a polymer modified cellulosic material containing fibers and fibrils and/or polymer modified cellulose material containing fibers and fibrils with a matrix polymer. In some embodiments, associating is or comprises compounding a polymer modified cellulosic material containing fibers and fibrils and/or polymer modified cellulose material containing fibers and fibrils with the matrix polymer. In some embodiments, a composite is formed through melt mixing and/or solution mixing. In some embodiments, a composite is processed via extrusion, compression molding, injection molding, and/or fused layer modeling process.

In some embodiments, a matrix polymer is a thermoplastic. In some embodiments, a thermoplastic is or comprises acrylonitrile butadiene styrene (ABS), polyethylene terephthalate glycol modified (PETG), poly(latic acid) (PLA), polypropylene (PP), polybutylene terephthalate (PBT), and/or high density polyethylene (HDPE). In some embodiments, a matrix polymer is or comprises poly(latic acid) (PLA). In some embodiments, an amount of polymer modified cellulosic material containing fibers and fibrils and/or polymer modified cellulose material containing fibers and fibrils in a composite is between 0.5% and 50% by weight of the composite.

The present disclosure also provides, among other things, methods of making cellulosic material (e.g., wood pulp) that exhibit said unique properties.

### BRIEF DESCRIPTION OF THE DRAWING

FIG. 1 shows an exemplary grafting-through polymerization approach used for surface modification of bleached softwood Kraft pulp (BSKP): first, the hydroxyl surface groups of the BSKP fibers were reacted with methacrylic anhydride to generate Met-BSKP. Then, polymer-modified BSKP were obtained by co-polymerization of Met-BSKP with Acrylamide (AM) or methyl methacrylate (MMA) monomers.

FIG. 2 depicts fines percent versus net cumulative energy applied in the fibrillation of 2.2 wt % modified BSKP by supermass colloider (SMC). Error bars are the range of values for two Morfi measurements. SMC conditioning time was 20 min of circulation with no load before measurements.

FIG. 3 shows SEM images of unmodified BSKP, Met-BSKP, and polymer modified BSKP samples before and after fibrillation produced at 500× magnification. All scale bars represent 5 μm. All the samples were isolated and dried by freeze drying.

FIG. 4 depicts a) water retention value (WRV) measurements of modified BSKP before and after fibrillation, b) hard-to-remove (HR) water values of unmodified and modified BSKP after fibrillation (cellulose nanofibril [CNF] samples), and c) complex viscosity of unmodified and modified BSKP after fibrillation (CNF samples) as a function of angular frequency at 1 wt % in water. Error bars are standard deviation for 3 trials. A P-value of <0.05 was considered statistically significant(S); P-values of >0.05 were considered not significant (NS). Modified BSKP and CNF samples are compared to unmodified BSKP (∘) and CNF (‡), respectively.

FIG. 5 depicts fiber length distribution of a) CNF-AM and Met-CNF-AM, b) CNF-MMA and Met-CNF-MMA, and fiber width distribution of c) CNF-AM and Met-CNF-AM, and d) CNF-MMA and MET-CNF-MMA using Morfi analysis.

FIG. 6 shows an exemplary schematic of two routes of BSKP modification and fibrillation to prepare polymer modified CNFs. The upper path focused on the full modification of BSKP then fibrillation. The bottom path is modification of fibrillated methacrylate pulp (Met-CNF) with AM and MMA polymers.

FIGS. 7A and 7B depict reaction and production schemes. FIG. 7A depicts grafting through polymerization of a reactive methacrylate handle on cellobiose with exemplary monomers (see Red Dashed Region) FIG. 7B depicts processing steps to produce extruded PLA pellets reinforced with polymer modified CNFs for compression molding and additive manufacturing tests. Also shown is a schematic demonstrating fibrillar alignment induced by shear during 3D printing of Poly (Lactic Acid) (PLA) composite test samples. The two directions that tensile and DMA bars were milled from the samples are denoted by the dotted dog bone shapes.

FIG. 8 shows complex viscosity of polymer-modified cellulose nanofibril (CNF) suspensions and unmodified controls as a function of frequency at 1 wt % in water (left), and ζ-Potential measurements of the modified fibrils at 0.01 wt % (right).

FIGS. 9A-9H depicts exemplary scanning electron microscopy (SEM) images of spray-dried unmodified cellulose nanofibrils (CNFs) and modified CNFs produced at 4000× magnification. All scale bars represent 6 μm. FIG. 9A depicts an exemplary SEM image of spray dried CNF control samples. FIG. 9B depicts an exemplary SEM image of spray dried poly (methacrylamide) modified CNFs (PMAM-MetCNFs). FIG. 9C depicts an exemplary SEM image of poly(N-isopropylacrylamide) modified CNFs (PNIPAM-MetCNFs) samples. FIG. 9D depicts an exemplary SEM image of poly(oligoethylene glycol methyl ether methacrylate polymer) modified CNFs (POEGMA-MetCNFs) samples. FIG. 9E depicts an exemplary SEM image of poly(2-hydroxyethyl methacrylate polymer) modified CNFs (PHEMA-MetCNFs) samples. FIG. 9F depicts an exemplary SEM image of poly(acrylic acid) modified CNFs (PAA-MetCNFs) samples. FIG. 9H depicts an exemplary SEM image of poly(acrylamide) modified CNFs (PAM-MetCNFs) samples. FIG. 9H depicts an exemplary SEM image of poly (methacrylic acid) modified CNFs (PMAA-MetCNFs) samples.

FIG. 10 shows Brunauer-Emmett-Teller (BET) specific surface area (SSA) values of spray dried unmodified and polymer modified CNF samples.

FIG. 11 shows dispersive components (γd) (left), polar components (γsp) of the surface energy for solid samples at different total fractional surface coverages of probe gasses (middle), and ratio between work of adhesion (Wadh) (interaction between the sample and the PLA control) and work of cohesion (Wcoh) (interaction between the sample and itself) for the different samples as a function of total fractional surface coverage defined as the moles of probe gas on the surface (n) divided by the theoretical moles of probe gas required for monolayer coverage (n0) (right). The black dotted line represents the crossover point (Wadh/Wcoh=1) between the preference for cohesion (<1) and the preference for adhesion (>1) in the fibril-PLA system.

FIGS. 12A and 12B show tensile testing data for spray-dried CNFs compounded into PLA composites. FIG. 12A shows tensile strength of composites made at different fibril reinforcement loading levels (top), and relative changes in tensile strength for spray-dried modified CNF composites relative to the strength and modulus of spray-dried unmodified CNF composites at the same loading level (bottom). FIG. 12B shows tensile modulus data of composites made at different fibril reinforcement loading levels (top), and tensile modulus for spray-dried modified CNF composites relative to the strength and modulus of spray-dried unmodified CNF composites at the same loading level (bottom). Error bars in 12A (top) and 12B (top) are the standard deviations of the tested data, and error bars in 12A (bottom) and 12B (bottom) are calculated errors propagated from the tensile standard deviations.

FIGS. 13A-13D depict exemplary SEM images of fracture surfaces from tensile testing samples of PLA composites at 10 wt. % loading levels at 1000× (left) and 5000× (right) magnifications. Red circles identify examples of fibril aggregation, and the black circles identify unaggregated fibrils. FIG. 13A depicts exemplary SEM images of spray dried CNF control samples. FIG. 13B depicts exemplary SEM images of poly (N-isopropylacrylamide) modified CNFs (PNIPAM-MetCNFs) samples. FIG. 13C depicts exemplary SEM images of spray dried poly (methacrylamide) modified CNFs (PMAM-MetCNFs). FIG. 13D depicts exemplary SEM images of poly (oligoethylene glycol methyl ether methacrylate polymer) modified CNFs (POEGMA-MetCNFs) samples.

FIGS. 14A and 14B show storage (G′) and loss (G″) modulus of PLA composites filled with unmodified and modified CNFs at two reinforcement concentrations. Colored arrows denote the crossover point between G′ and G″. FIG. 14A shows storage (filled) and loss (unfilled) modulus of the PLA filled with 5 wt. % of reinforcements. FIG. 14B shows storage (filled) and loss (unfilled) modulus of the PLA filled with 10 wt. % of reinforcements.

FIG. 15 shows onset temperature of cold crystallization (Tcc) (left) and onset temperature of melting (Tm) (right) as a function of the mass fraction of reinforcement in the composite.

FIG. 16 depicts exemplary images of 3D printed spray-dried unmodified CNFs (control) and modified CNFs samples.

FIG. 17 shows tensile strength (left) and tensile modulus (right) of 3D printed samples milled along the bead direction (x direction) and across the interlayer direction (z direction) with compression molded anisotropic control samples of the pellets used for 3D printing.

FIG. 18 shows complex viscosity of pellets (left) and storage (G′) and loss (G″) moduli as a function of angular frequency at 200° C. (right).

FIG. 19 shows storage moduli (left) and loss moduli (right) of tested composites measured by dynamic mechanical analysis (DMA).

FIG. 20 shows Fourier transform infrared (FTIR) characterization poly (N-isopropylacrylamide) modified CNFs (PNIPAM-MetCNFs) and poly(methacrylamide) modified CNFs (PMAM-MetCNFs) syntheses at different scale up multipliers starting with the original 0.15 g scale synthesis (1×).

FIG. 21 shows size-exclusion chromatography (SEC) elution curves of the PLA matrices from extruded pellets (left), printed composite samples (middle), and compression molded controls (right) either neat or compounded with polymer modified CNFs or the spray dried CNF control.

FIG. 22 shows tan delta (δ) of poly (N-isopropylacrylamide) modified CNFs (PNIPAM-MetCNFs) (top left), Spray-Dried (SD) CNF (top right), neat PLA (bottom left), and poly (methacrylamide) modified CNFs (PMAM-MetCNFs) (bottom right) composites in both printing directions and compression molded as a function of temperature measured by Dynamic Mechanical Analysis (DMA).

FIG. 23 depicts exemplary scanning electron microscopy (SEM) images of the unmodified spray-dried CNFs (left), poly (methacrylamide) modified CNFs (PMAM-MetCNFs) (middle), and poly(N-isopropylacrylamide) modified CNFs (PNIPAM-MetCNFs) (right).

FIG. 24 shows tensile strength (left) and tensile modulus (right) of large-scale spray dried reinforced PLA composites at different loading levels produced via small scale melt mixing and compression molding.

### DEFINITIONS

In this application, unless otherwise clear from context, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; and (iv) the terms “about” and “approximately” may be understood to permit standard variation as would be understood by those of ordinary skill in the art; and (v) where ranges are provided, endpoints are included.

Approximately or about: As used herein, the term “approximately” and “about” is intended to encompass normal statistical variation as would be understood by those of ordinary skill in the art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Associate: Two events or entities “associate” (also referred to herein as “associated” or “associating”) with one another, as that term is used herein, if the presence, level, degree, type and/or form of one is correlated with that of the other. For example, in some embodiments, two or more entities are physically “associated” with one another if they interact, directly or indirectly, so that they are and/or remain in physical proximity with one another. In some embodiments, two or more entities that are physically associated with one another are covalently linked to one another. In some embodiments, two or more entities that are physically associated with one another are not covalently linked to one another but are non-covalently associated, for example by means of hydrogen bonds, van der Waals interaction, hydrophobic interactions, magnetism, and combinations thereof.

Substantially: As used herein, the term “substantially” refers to the qualitative condition of exhibiting total or near-total extent or degree of a characteristic or property of interest. One of ordinary skill in the art will understand that chemical phenomena rarely, if ever, go to completion and/or proceed to completeness or achieve or avoid an absolute result. The term “substantially” is therefore used herein to capture the potential lack of completeness inherent in many chemical phenomena.

### DETAILED DESCRIPTION OF CERTAIN EMBODIMENTS

It is contemplated that compositions, methods, and processes of the present application encompass variations and adaptations developed using information from embodiments described in the following description. Adaptation and/or modification of compositions, methods, and processes described in the following description may be performed by those of ordinary skill in the relevant art.

Throughout the description, where compositions are described as having, including, or comprising specific components, or where processes and methods are described as having, including, or comprising specific steps, it is contemplated that, additionally, there are aspects of the present application that consist essentially of, or consist of, recited components, and that there are processes and methods according to the present application that consist essentially of, or consist of, recited processing steps.

It should be understood that order of steps or order for performing certain actions is immaterial so long as a described method remains operable. Moreover, two or more steps or actions may be conducted simultaneously.

Reference in the present application to any publication (each of which are hereby incorporated by reference in their entirety), for example, in the Background section, is not an admission that the publication serves as prior art with respect to any of the presented claims. The Background section is presented for purposes of clarity and is not meant as a description of prior art with respect to any claim. Headers are provided for the convenience of the reader and are not intended to be limiting with respect to claimed subject matter.

In some embodiments, the present disclosure provides methods including providing cellulosic material, modifying at least a portion of the cellulosic material to form a modified cellulosic material comprising an acrylate ester moiety, associating and covalently attaching to the modified cellulosic material a plurality of monomers through a water-borne polymerization at the acrylate ester moiety to form a modified cellulosic-polymer material, and fibrillation of the modified cellulosic-polymer material to form a polymer modified cellulosic material containing fibers and fibrils.

In some embodiments, the present disclosure provides methods including providing cellulosic material, modifying at least a portion of the cellulosic material to form a modified cellulosic material comprising an acrylate ester moiety, fibrillation of the modified cellulosic material comprising an acrylate ester moiety to form a modified cellulosic material containing fibers and fibrils, and associating and covalently attaching to the modified cellulosic material containing fibers and fibrils a plurality of monomers through a water-borne polymerization at the acrylate ester moiety to form a polymer modified cellulosic material containing fibers and fibrils.

In some embodiments, the present disclosure provides methods including providing a cellulose containing fibers and fibrils, modifying at least a portion of the cellulose containing fibers and fibrils in water to form a modified cellulose comprising an acrylate ester moiety, and associating and covalently attaching to the modified cellulose a plurality of monomers through a water-borne polymerization at the acrylate ester moiety to form a polymer modified cellulose material containing fibers and fibrils.

### Cellulosic Material

Cellulosic materials have been used across diverse industrial sectors to fabricate a wide array of cellulose commodities, e.g., fabrics, paper, corrugated fiberboard, and cellulose nanofibrils (CNFs) (see, e.g., Fu Q, Cui C, Meng L, et al (2021) Emerging cellulose-derived materials: a promising platform for the design of flexible wearable sensors toward health and environment monitoring. Mater Chem Front 5:2051-2091; Fatema N, Ceballos R M, Fan C (2022) Modifications of cellulose-based biomaterials for biomedical applications. Front Bioeng Biotechnol 10; and Seddiqi H, Oliaei E, Honarkar H, et al (2021) Cellulose and its derivatives: towards biomedical applications. Cellulose 28:1893-1931). In addition, cellulosic material provides a promising platform for a next generation of biodegradable reinforcement material. Compared to conventional reinforcements, cellulosic materials offer a series of advantages, e.g., lower density (1.5 g/cm³), better recyclability and disposal, lower price, reduced abrasion to processing machinery, and carbon dioxide neutrality.

According to various embodiments, any of a variety of cellulosic materials may be used in provided compositions and/or methods. In some embodiments, a cellulosic material is or comprises wood pulp, wheat straw pulp, highly refined flax fiber, agricultural waste, wood, wood waste, spent pulping/fractionation liquors, algal biomass, food waste, grasses, straw, corn stover, corn fiber, agricultural products and residuals, flax fiber, hemp fiber, forest residuals, saw dust, wood shavings, sludges and municipal solid waste, bacterial cellulose, bagasse, bamboo, hemp, jute, cotton, kenaf, woodchips, recycled paper and fiber, and mixtures thereof.

### Modified Cellulosic Material

In one aspect, the present disclosure is directed to improving physical and/or manufacturing properties of cellulosic material (e.g., wood pulp). In some embodiments, the present disclosure provides improved cellulosic material with low embodied energy and tunable surface chemistry without the need for environmentally harmful solvents or byproducts.

According to various embodiments, modifying at least a portion of cellulosic material to form a modified cellulosic material may occur in any of a variety of ways. In some embodiments, the present disclosure provides methods of modifying at least a portion of a cellulosic material under dry conditions. In some embodiments, the present disclosure provides methods of modifying at least a portion of cellulosic material under non-dry conditions (e.g., in a liquid).

In some embodiments, a cellulosic material is modified in a solvent. In some embodiments, a solvent is or comprises an inorganic solution. In some embodiments, an inorganic solution is or comprises water.

In some embodiments, a solvent is or comprises any suitable buffer for a particular application. In some embodiments, a solvent is or comprises a commercially acceptable buffer (e.g., water).

In accordance with various embodiments, a reaction volume may comprise a large-scale reaction (e.g., 50 L or greater). In some embodiments, a reaction volume is at least about 50 L. In some embodiments, a reaction volume is at least about 100 L. In some embodiments, a reaction volume is at least about 150 L. In some embodiments, a reaction volume is at least about 200 L. In some embodiments, a reaction volume is at least about 250 L. In some embodiments, a reaction volume is at least about 300 L. In some embodiments, a reaction volume is at least about 350 L. In some embodiments, a reaction volume is at least about 400 L. In some embodiments, a reaction volume is at least about 450 L. In some embodiments, a reaction volume is at least about 500 L.

In some embodiments, a reaction solution has a pH of at least about 3. In some embodiments, a reaction solution has a pH of at least about 3.5. In some embodiments, a reaction solution has a pH of at least about 4. In some embodiments, a reaction solution has a pH of at least about 4.5. In some embodiments, a reaction solution has a pH of at least about 5. In some embodiments, a reaction solution has a pH of at least about 5.5. In some embodiments, a reaction solution has a pH of at least about 6. In some embodiments, a reaction solution has a pH of at least about 6.5. In some embodiments, a reaction solution has a pH of at least about 7. In some embodiments, a reaction solution has a pH of at least about 7.5. In some embodiments, a reaction solution has a pH of at least about 8. In some embodiments, a reaction solution has a pH of at least about 8.5. In some embodiments, a reaction solution has a pH of at least about 9. In some embodiments, a reaction solution has a pH of at least about 9.5. In some embodiments, a reaction solution has a pH of at least about 10. In some embodiments, a reaction solution has a pH of at least about 10.5. In some embodiments, a reaction solution has a pH of at least about 11. In some embodiments, a reaction solution has a pH of at least about 11.5. In some embodiments, a reaction solution has a pH of at least about 12.

In some embodiments, at least a portion of a cellulosic material is modified at a substantially constant temperature. In some embodiments, at least a portion of a cellulosic material is modified at a varied temperature. In some embodiments, at least a portion of a cellulosic material is modified at a temperature between about 80° C. and 220° C. (e.g., about 80° C. and 200° C., about 80° C. to 150° C., about 80° C. to 100° C., about 100° C. to 200° C.), inclusive. In some embodiments, at least a portion of a cellulosic material is modified at a temperature between about −4° C. and 220° C. (e.g., about −4° C. and 200° C., about −4° C. and 150° C., about −4° C. and 100° C., about −4° C. and 50° C.), inclusive.

### Reactive Functional Groups or Handles

Various embodiments provide and/or take advantage of a variety of compositions that are compatible with methods provided herein. In some embodiments, a cellulosic material is modified with one or more reactive functional groups or handles. In some embodiments, a surface of cellulosic material is modified with one or more reactive functional groups or handles. In some embodiments, one or more surface bound reactive functional groups or handles may facilitate initiation of additional chemical modification(s) (e.g., addition of monomers) to a surface of a cellulosic material.

In some embodiments, at least a portion of a cellulosic material is modified to form a modified cellulosic material comprising one or more reactive functional groups or handles. In some embodiments, one or more reactive functional groups or handles is or comprises an acrylate ester moiety. In some embodiments, one or more reactive functional groups or handles is or comprises a methacrylate ester moiety.

In some embodiments, at least a portion of a cellulosic material is modified to form a cellulosic material comprising one or more acrylate ester moiety. In some embodiments, at least a portion of a cellulosic material surface is modified to form a modified cellulosic material comprising one or more acrylate ester moiety.

In some embodiments, at least a portion of a surface of a cellulosic material is modified to form a modified cellulosic material comprising an acrylate ester moiety. In some embodiments, at least a portion of a surface of a cellulosic material is modified to form a modified cellulosic material comprising one or more acrylate ester moiety. In some embodiments, an acrylate ester moiety is or comprises one or more methacrylate ester moiety.

In some embodiments, a modified cellulosic material comprises one or more surface bound reactive functional groups or handles. In some embodiments, one or more reactive functional groups or handles is or comprises an acrylate ester moiety. In some embodiments, one or more reactive functional groups or handles is or comprises a methacrylate ester moiety.

In some embodiments, a modified cellulosic material comprises one or more acrylate ester moiety. In some embodiments, a modified cellulosic material comprises one or more methacrylate ester moiety.

In some embodiments, modifying is or comprises associating a cellulosic material with one or more acrylic anhydride. In some embodiments, an acrylic anhydride is a methacrylic anhydride. In some embodiments, an acrylic anhydride is not maleic anhydride. In some embodiments, associating is or comprises one or more covalent bonding events.

In accordance with various embodiments, provided methods comprise associating and covalently attaching to a modified cellulosic material a plurality of monomers at an acrylate ester moiety prior to fibrillation. In accordance with various embodiments, provided methods comprise associating and covalently attaching to a modified cellulosic material a plurality of monomers at an acrylate ester moiety to form a cellulosic-polymer material prior to fibrillation. In some embodiments, a plurality of monomers is added to a plurality of reactive functional groups or handle through a water-borne polymerization reaction.

In some embodiments, a water-borne polymerization reaction comprises an emulsion polymerization reaction. In some embodiments, a water-borne polymerization reaction comprises an inverse emulsion polymerization reaction.

### Fibrillation

In accordance with various embodiments, fibrillation of a modified cellulosic material (e.g., a modified cellulosic-polymer material, a modified cellulosic material comprising an acrylate ester moiety) may occur under any of a variety of conditions.

In some embodiments, provided methods comprise fibrillation of a modified cellulosic material (e.g., comprising an acrylate ester moiety) to form a modified cellulosic material containing fibers and fibrils, and associating and covalently attaching to a modified cellulosic material containing fibers and fibrils a plurality of monomers at an acrylate ester moiety. In some embodiments, provided methods comprise fibrillation of a modified cellulosic material to form a modified cellulosic material containing fibers and fibrils, and associating and covalently attaching to a modified cellulosic material containing fibers and fibrils a plurality of monomers at an acrylate ester moiety (e.g., through water-borne polymerization) to form a polymer modified cellulosic material containing fibers and fibrils.

In some embodiments, a modified cellulosic material is in an aqueous suspension during fibrillation. In some embodiments, a reaction solution comprises water. In some embodiments, a reaction solution comprises a eutectic mixture (e.g., deep eutectic solvents). In some embodiments, a reaction solution comprises a water-solvent mixture. In some embodiments, a reaction solution comprises a water-buffer mixture.

In some embodiments, fibrillation is mechanical. In accordance with various embodiments, fibrillation may be accomplished using any application-appropriate method or device. By way of non-limiting example, in some embodiments, via mechanical fibrillation (e.g., grinding, crushing, milling, ultrasonication, screw extrusion, steam explosion). In some embodiments, fibrillation may occur at least in part through use of an Ultrafine Grinder. In some embodiments, an Ultrafine Grinder is or comprises a supermasscolloider (SMC).

In some embodiment, the modified cellulosic material moiety is fibrillated using a refiner.

In some embodiments, provided methods may reduce energy to produce modified cellulosic material containing fibers and fibrils. In some embodiments, provided methods may substantially reduce energy required to produce polymer modified cellulosic material containing fibers and fibrils. In some embodiments, provided methods may reduce energy consumption to produce cellulosic material containing fibers and fibrils during refining.

In some embodiments, provided methods may reduce energy consumption to produce modified cellulosic material containing fibers and fibrils by at least about 5%, 10%, 15%, 20, 25%, 30%, 35%, 40%, 45%, 50%, 55%, 60%, 65%, or 70% as compared to an unmodified cellulosic material (i.e., a cellulosic material not comprising a reactive functional group or handle, e.g., an acrylate ester moiety).

### Polymerization

In some embodiments, a modified cellulosic material and/or a modified cellulosic material containing fibers and fibrils comprises at least one monomer. In some embodiments, a monomer is or comprises a radical polymerizable monomer. In some embodiments, a monomer is or comprises an acrylate, an acrylic acid, an acrylamide, a styrene, a diene (e.g., butadiene, isoprene, chloroprene), acrylonitrile, a vinyl ether, or a vinyl acetate.

In some embodiments, a modified cellulosic material and/or a modified cellulosic material containing fibers and fibrils comprises one or more acrylate selected from methyl methacrylate (MMA), butyl methacrylate (BMA), hexyl methacrylate (HMA), 2,2,2-trifluoroethyl methacrylate (TFEM), oligoethylene glycol methyl ether methacrylate (OEGMA), 2-hydroxyethyl methacrylate (HEMA), and dimethyl 2-methylenesuccinate (DMI).

In some embodiments, a modified cellulosic material and/or a modified cellulosic material containing fibers and fibrils comprises one or more acrylic acid selected from acrylic acid (AA) and methacrylic acid (MAA).

In some embodiments, a modified cellulosic material and/or a modified cellulosic material containing fibers and fibrils comprises one or more acrylamide selected from acrylamide (AM), N-isopropylacrylamide (NIPAM), methacrylamide (MAM), N,N-Dimethylacrylamide (DMAA), and N-[3-(Dimethylamino)propyl]methacrylamide (DMAPMA).

In some embodiments, a modified cellulosic material and/or a modified cellulosic material containing fibers and fibrils comprises one or more unsubstituted styrene (Sty).

In some embodiments, a modified cellulosic-polymer material and/or a polymer modified cellulosic material containing fibers and fibrils comprises at least one polymer selected from an acrylate ester polymer, an acrylic acid polymer, an acrylamide polymer, a styrene polymer, a diene polymer, vinyl ether polymer, and/or a vinyl acetate polymer.

In some embodiments, a modified cellulosic-polymer material and/or a polymer modified cellulosic material containing fibers and fibrils comprises at least one acrylate ester polymer selected from methyl methacrylate polymer (MMA), butyl methacrylate (BMA) polymer, hexyl methacrylate (HMA) polymer, 2,2,2-trifluoroethyl methacrylate (TFEM) polymer, oligoethylene glycol methyl ether methacrylate (OEGMA) polymer, 2-hydroxyethyl methacrylate (HEMA) polymer, dimethyl 2-methylenesuccinate (DMI) polymer, methyl acrylate (MA) polymer, butyl acrylate (BA) polymer, hexyl acrylate (HA) polymer, and oligoethylene glycol methyl ether acrylate (OEGA) polymer.

In some embodiments, a modified cellulosic-polymer material and/or a polymer modified cellulosic material containing fibers and fibrils comprises at least one acrylic acid polymer selected from acrylic acid (AA) polymer and methacrylic acid (MAA) polymer.

In some embodiments, a modified cellulosic-polymer material and/or a polymer modified cellulosic material containing fibers and fibrils comprises at least one acrylamide polymer selected from acrylamide (AM) polymer, N-isopropylacrylamide (NIPAM) polymer, methacrylamide (MAM) polymer, N,N-Dimethylacrylamide (DMAA) polymer, and N-[3-(Dimethylamino)propyl]methacrylamide (DMAPMA) polymer.

In some embodiments, a modified cellulosic-polymer material and/or a polymer modified cellulosic material containing fibers and fibrils comprises at least one unsubstituted styrene polymer (Sty).

### Cellulose Containing Fibers and Fibrils

Prior to the present disclosure, cellulose containing fibers and fibrils (e.g., cellulose nanofibrils (CNFs)) were often obtained by directly submitting cellulosic material to shearing forces until the fiber wall is fibrillated into individual fibrils (see, e.g., Gorur Y C, Reid M S, Montanari C, Larsson P T, Larsson P A, Wågberg L. Advanced Characterization of Self-Fibrillating Cellulose Fibers and Their Use in Tunable Filters. ACS Appl Mater Interfaces. 2021 Jul. 14; 13 (27): 32467-32478). In some embodiments, cellulose containing fibers and fibrils (e.g., CNFs) may be isolated from any cellulosic material prior to modification (e.g., with an acrylate ester moiety or other functionalized group). In some embodiments, cellulose containing fibers and fibrils (e.g., CNFs) are isolated from wood-based material, such as, for example, wood pulp (e.g., bleached Kraft pulp and/or bleached sulfite pulp). In some embodiments, cellulose containing fibers and fibrils may be or comprise wood fibers, paper fibers, pulp fibers, rice-husk flour, flax, jute, sisal, hemp, microcrystalline cellulose (MCC), nanofibrillated cellulose (NFC), cellulose nanocrystals (CNCs). Among them, nanofibrillated cellulose and cellulose nanocrystals are generally considered the elementary fibrils of cellulose materials, e.g., cellulose nanofibrils (CNFs).

In some embodiments, a cellulose nanofibril may be a fiber or particle having any shape wherein at least one dimension (e.g., diameter, width, thickness, and/or length) of about 100 nanometers or less. In some embodiments, a cellulose nanofibril may have a diameter between 5 and 20 (e.g., about 5 to 15, about 5 to 10) nanometers, inclusive. In some embodiments, cellulose nanofibrils may have a length between about 10 and 5,000 (e.g., about 10 to 4,000, about 10 to 3,000, about 10 to 2,000, about 10 to 1,000, or about 10 to 500) nanometers, inclusive.

### Modified Cellulose Containing Fibers and Fibrils

In some embodiments, the present disclosure provides methods of modifying at least a portion of cellulose containing fibers and fibrils (e.g., CNFs) under dry conditions. In some embodiments, the present disclosure provides methods of modifying at least a portion of cellulose containing fibers and fibrils (e.g., CNFs) under non-dry conditions (e.g., in a liquid).

In some embodiments, a cellulose containing fibers and fibrils (e.g., CNFs) is modified in a solvent. In some embodiments, a solvent is or comprises an inorganic solution. In some embodiments, an inorganic solution is or comprises water.

In some embodiments, a solvent is or comprises any suitable buffer for a particular application. In some embodiments, a solvent is or comprises a commercially acceptable buffer (e.g., water, carbonate-bicarbonate buffer).

In accordance with various embodiments, a reaction volume may comprise a large scale reaction (e.g., 50 L or greater). In some embodiments, a reaction volume is at least about 50 L. In some embodiments, a reaction volume is at least about 100 L. In some embodiments, a reaction volume is at least about 150 L. In some embodiments, a reaction volume is at least about 200 L. In some embodiments, a reaction volume is at least about 250 L. In some embodiments, a reaction volume is at least about 300 L. In some embodiments, a reaction volume is at least about 350 L. In some embodiments, a reaction volume is at least about 400 L. In some embodiments, a reaction volume is at least about 450 L. In some embodiments, a reaction volume is at least about 500 L.

In some embodiments, a reaction solution has a pH of at least about 3. In some embodiments, a reaction solution has a pH of at least about 3.5. In some embodiments, a reaction solution has a pH of at least about 4. In some embodiments, a reaction solution has a pH of at least about 4.5. In some embodiments, a reaction solution has a pH of at least about 5. In some embodiments, a reaction solution has a pH of at least about 5.5. In some embodiments, a reaction solution has a pH of at least about 6. In some embodiments, a reaction solution has a pH of at least about 6.5. In some embodiments, a reaction solution has a pH of at least about 7. In some embodiments, a reaction solution has a pH of at least about 7.5. In some embodiments, a reaction solution has a pH of at least about 8. In some embodiments, a reaction solution has a pH of at least about 8.5. In some embodiments, a reaction solution has a pH of at least about 9. In some embodiments, a reaction solution has a pH of at least about 9.5. In some embodiments, a reaction solution has a pH of at least about 10. In some embodiments, a reaction solution has a pH of at least about 10.5. In some embodiments, a reaction solution has a pH of at least about 11. In some embodiments, a reaction solution has a pH of at least about 11.5. In some embodiments, a reaction solution has a pH of at least about 12.

In some embodiments, at least a portion of a cellulose containing fibers and fibrils (e.g., CNFs) is modified at a constant temperature. In some embodiments, at least a portion of a cellulose containing fibers and fibrils is modified at a varied temperature. In some embodiments, at least a portion of a cellulose containing fibers and fibrils (e.g., CNFs) is modified at a temperature between about 80° C. and 220° C. (e.g., about 80° C. and 200° C., about 80° C. to 150° C., about 80° C. to 100° C., about 100° C. to 200° C.), inclusive. In some embodiments, at least a portion of a cellulosic material is modified at a temperature between about −4° C. and 220° C. (e.g., about-4° C. and 200° C., about −4° C. and 150° C., about −4° C. and 100° C., about −4° C. and 50° C.), inclusive.

### Reactive Functional Groups or Handles

Various embodiments provide and/or take advantage of a variety of compositions that are compatible with methods provided herein. In some embodiments, a cellulose containing fibers and fibrils (e.g., CNFs) is modified with one or more reactive functional groups or handles. In some embodiments, a surface of a cellulose containing fibers and fibrils (e.g., CNFs) is modified with one or more reactive functional groups or handles. In some embodiments, one or more surface bound reactive functional groups or handles may facilitate initiation of additional chemical modification(s) (e.g., addition of monomers) to a surface of a cellulose containing fibers and fibrils.

In some embodiments, at least a portion of a cellulose containing fibers and fibrils (e.g., CNFs) is modified to form a modified cellulose containing fibers and fibrils (e.g., CNFs) comprising one or more reactive functional groups or handles. In some embodiments, one or more reactive functional groups or handles is or comprises an acrylate ester moiety. In some embodiments, one or more reactive functional groups or handles is or comprises a methacrylate ester moiety.

In some embodiments, at least a portion of a cellulose containing fibers and fibrils (e.g., CNFs) is modified to form a cellulose containing fibers and fibrils comprising one or more acrylate ester moiety. In some embodiments, at least a portion of a cellulose containing fibers and fibrils (e.g., CNFs) surface is modified to form a modified cellulose comprising one or more acrylate ester moiety.

In some embodiments, at least a portion of a surface of a cellulose containing fibers and fibrils (e.g., CNFs) is modified to form a modified cellulose containing fibers and fibrils (e.g., CNFs) comprising an acrylate ester moiety. In some embodiments, at least a portion of a surface of a cellulose containing fibers and fibrils (e.g., CNFs) is modified to form a modified cellulose containing fibers and fibrils (e.g., CNFs) comprising one or more acrylate ester moiety. In some embodiments, an acrylate ester moiety is or comprises one or more methacrylate ester moiety.

In some embodiments, a modified cellulose containing fibers and fibrils (e.g., CNFs) comprises one or more surface bound reactive functional groups or handles. In some embodiments, one or more reactive functional groups or handles is or comprises an acrylate ester moiety. In some embodiments, one or more reactive functional groups or handles is or comprises a methacrylate ester moiety.

In some embodiments, a modified cellulose containing fibers and fibrils (e.g., CNFs) comprises one or more acrylate ester moiety. In some embodiments, a modified cellulose containing fibers and fibrils (e.g., CNFs) comprises one or more methacrylate ester moiety.

In some embodiments, modifying is or comprises associating a cellulose containing fibers and fibrils (e.g., CNFs) with one or more acrylic anhydride. In some embodiments, an acrylic anhydride is a methacrylic anhydride. In some embodiments, an acrylic anhydride is not maleic anhydride. In some embodiments, associating is or comprises one or more covalent bonding events.

### Polymerization

In accordance with various embodiments, provided methods comprise associating and covalently attaching to a modified cellulose containing fibers and fibrils (e.g., CNFs) a plurality of monomers at an acrylate ester moiety. In some embodiment, provided methods comprise associating and covalently attaching to a modified cellulose containing fibers and fibrils (e.g., CNFs) a plurality of monomers at an acrylate ester moiety to form a polymer modified cellulose material containing fibers and fibrils.

In some embodiments, a modified cellulose containing fibers and fibrils (e.g., CNFs) comprises at least one monomer. In some embodiments, a monomer is or comprises a radical polymerizable monomer. In some embodiments, a monomer is or comprises an acrylate, an acrylic acid, an acrylamide, a styrene, a diene (e.g., butadiene, isoprene, chloroprene), acrylonitrile, a vinyl ether, or a vinyl acetate.

In some embodiments, a modified cellulose containing fibers and fibrils (e.g., CNFs) comprises one or more acrylate selected from methyl methacrylate (MMA), butyl methacrylate (BMA), hexyl methacrylate (HMA), 2,2,2-trifluoroethyl methacrylate (TFEM), oligoethylene glycol methyl ether methacrylate (OEGMA), 2-hydroxyethyl methacrylate (HEMA), and dimethyl 2-methylenesuccinate (DMI).

In some embodiments, a modified cellulose containing fibers and fibrils (e.g., CNFs) comprises one or more acrylic acid selected from acrylic acid (AA) and methacrylic acid (MAA).

In some embodiments, a modified cellulose containing fibers and fibrils (e.g., CNFs) comprises one or more acrylamide selected from acrylamide (AM), N-isopropylacrylamide (NIPAM), methacrylamide (MAM), N,N-Dimethylacrylamide (DMAA), and N-[3-(Dimethylamino)propyl]methacrylamide (DMAPMA).

In some embodiments, a modified cellulose containing fibers and fibrils (e.g., CNFs) comprises one or more unsubstituted styrene (Sty).

In some embodiments, a polymer modified cellulose material containing fibers and fibrils at least one polymer selected from an acrylate ester polymer, an acrylic acid polymer, an acrylamide polymer, a styrene polymer, a diene polymer, vinyl ether polymer, and/or a vinyl acetate polymer.

In some embodiments, a polymer modified cellulose material containing fibers and fibrils at least one acrylate ester polymer selected from methyl methacrylate polymer (MMA), butyl methacrylate (BMA) polymer, hexyl methacrylate (HMA) polymer, 2,2,2-trifluoroethyl methacrylate (TFEM) polymer, oligoethylene glycol methyl ether methacrylate (OEGMA) polymer, 2-hydroxyethyl methacrylate (HEMA) polymer, dimethyl 2-methylenesuccinate (DMI) polymer, methyl acrylate (MA) polymer, butyl acrylate (BA) polymer, hexyl acrylate (HA) polymer, and oligoethylene glycol methyl ether acrylate (OEGA) polymer.

In some embodiments, a polymer modified cellulose material containing fibers and fibrils comprises at least one acrylic acid polymer selected from acrylic acid (AA) polymer and methacrylic acid (MAA) polymer.

In some embodiments, a polymer modified cellulose material containing fibers and fibrils comprises at least one acrylamide polymer selected from acrylamide (AM) polymer, N-isopropylacrylamide (NIPAM) polymer, methacrylamide (MAM) polymer, N,N-Dimethylacrylamide (DMAA) polymer, and N-[3-(Dimethylamino)propyl]methacrylamide (DMAPMA) polymer.

In some embodiments, a polymer modified cellulose material containing fibers and fibrils comprises at least one unsubstituted styrene polymer (Sty).

Preparing a Polymer Modified Cellulosic Material Containing Fibers and Fibrils and/or a Polymer Modified Cellulose Material Containing Fibers and Fibrils

In accordance with various embodiments, one or more surface bound polymer may modify a surface energetics of a polymer modified cellulosic material containing fibers and fibrils and/or a polymer modified cellulose material containing fibers and fibrils. Without wishing to be bound by any particular theory, one or more surface bound polymeric species attached to a surface of a polymer modified cellulosic material containing fibers and fibrils and/or a polymer modified cellulose material containing fibers and fibrils may preserve fibrillar architecture during drying and/or provide unique opportunities when tailoring interfaces for functional materials.

In accordance with various embodiments, provided methods comprise preparing a polymer modified cellulosic material containing fibers and fibrils and/or a polymer modified cellulose material containing fibers and fibrils for addition to a matrix polymer.

In some embodiments, preparing a polymer modified cellulosic material containing fibers and fibrils and/or a polymer modified cellulose material containing fibers and fibrils includes drying a polymer modified cellulosic material containing fibers and fibrils and/or a polymer modified cellulose material containing fibers and fibrils. Exemplary, non-limiting methods of drying include those described in U.S. Pat. No. 8,372,320, issued on Feb. 12, 2013, the disclosure of which is hereby incorporated by reference in its entirety

In some embodiments, preparing may be or comprise one or more of the following steps: drying a polymer modified cellulosic material containing fibers and fibrils and/or a polymer modified cellulose material containing fibers and fibrils, cooling a polymer modified cellulosic material containing fibers and fibrils and/or a polymer modified cellulose material containing fibers and fibrils, and granulating a dried polymer modified cellulosic material containing fibers and fibrils and/or a polymer modified cellulose material containing fibers and fibrils to form a polymer modified cellulosic material containing fibers and fibrils masterbatch and/or a polymer modified cellulose material containing fibers and fibrils masterbatch.

In some embodiments, drying may be or comprise spray drying. As used herein, the phrase “spray drying” is defined as a processing method to convert a suspension, solution, or emulsion into a solid powder in one single process step. Spray drying involves evaporation of moisture from an atomized feed or spray of the suspension by mixing the spray and a drying medium. The drying medium is typically air or nitrogen.

Drying may be or comprise oven drying. Oven drying is defined as a process to convert the suspension into a solid powder or mat in a single step. Oven drying involves evaporation of moisture through forced convection in a heated chamber.

Drying may be or comprise freeze drying. Freeze drying is defined as a process where first the suspension is frozen or vitrified through cooling. This cooling can be accomplished through refrigeration and/or immersion in a cryogenic fluid. After freezing, the frozen liquid is removed through sublimation under vacuum.

In some embodiments, cooling may be or comprise removing a polymer modified cellulosic material containing fibers and fibrils and/or a polymer modified cellulose material containing fibers and fibrils from a heat source (e.g., air cooling). In some embodiments, cooling may be or comprise active cooling (e.g., refrigeration and/or freezing) or through forced convection of air or other gas over the surface of the material.

In some embodiments, a polymer modified cellulosic material containing fibers and fibrils and/or a polymer modified cellulose material containing fibers and fibrils is characterized as a reduction in fiber and/or fibril aggregation upon drying as compared to an unmodified cellulosic material (i.e., a cellulosic material not comprising a reactive functional group or handle, e.g., an acrylate ester moiety) and/or an unmodified cellulose containing fibers and fibrils (i.e., a cellulose containing fibers and fibrils not comprising a reactive functional group or handle, e.g., an acrylate ester moiety). In some embodiments, a cellulose-polymer material is characterized as an increase in specific surface area upon drying as compared to an unmodified cellulosic material (i.e., a cellulosic material not comprising a reactive functional group or handle, e.g., an acrylate ester moiety) and/or an unmodified cellulose containing fibers and fibrils (i.e., a cellulose containing fibers and fibrils not comprising a reactive functional group or handle, e.g., an acrylate ester moiety).

### Matrix Polymers

In some embodiments, provided methods described herein facilitate association of a matrix polymer (e.g., thermoplastic) with a polymer modified cellulosic material containing fibers and fibrils and/or a polymer modified cellulose material containing fibers and fibrils. In some embodiments, provided methods described herein facilitate efficient association of a matrix polymer (e.g., thermoplastic) with a polymer modified cellulosic material containing fibers and fibrils and/or a polymer modified cellulose material containing fibers and fibrils. In some embodiments, a polymer modified cellulosic material containing fibers and fibrils and/or a polymer modified cellulose material containing fibers and fibrils is substantially dry at the time of initiating association with a matrix polymer.

In some embodiments, a matrix polymer is a thermoplastic. In some embodiments, a thermoplastic is or comprises acrylonitrile butadiene styrene (ABS), polyethylene terephthalate glycol modified (PETG), poly(latic acid) (PLA), polypropylene (PP), polybutylene terephthalate (PBT), and/or high density polyethylene (HDPE).

In some embodiments, associating is or comprises compounding a polymer modified cellulosic material containing fibers and fibrils and/or a polymer modified cellulose material containing fibers and fibrils with the matrix polymer.

In some embodiments, association of a polymer modified cellulosic material containing fibers and fibrils and/or a polymer modified cellulose material containing fibers and fibrils with a matrix polymer forms a composite. In some embodiments, a composite is formed through melt mixing, solution mixing, rotational molding, thermoforming, and/or fiber spinning. In some embodiments, a composite is processed via extrusion, compression molding, injection molding, and/or fused layer modeling process.

### Biodegradable Polymers

Interest in biodegradable polymers has grown tremendously as requests for low environmental stress materials, low-maintenance, and high-durability products have increased (see, e.g., Peng, X., et al. “A review on emerging biodegradable polymers for environmentally benign transient electronic skins.” Journal of Materials Science 56 (2021): 16765-16789). However, there are several scientific challenges associated with biodegradable polymers (e.g., poly(lactic acid) (PLA)). As but one example, an ideal biodegradable polymer has similar and/or better physical properties as compared to a non-biodegradable plastics. This can be challenging as the mechanical properties of commodity materials range from high strength and stiffness to high elongation at break and incredible toughness. In addition, thermal demands of processing and application can further exacerbate this challenge.

To address such challenges, biodegradable polymers can be reinforced with fibrous materials that impart various properties to a composite. Traditional reinforcements that have been used include carbon, glass, or aramid fibers (see, e.g., Prashanth, S., et al. “Fiber reinforced composites—a review.” J. Mater. Sci. Eng 6.03 (2017): 2-6). Without wishing to be bound by any theory, the environmental impact of biodegradable polymers could be further mitigated by reinforcement with a polymer modified cellulosic material containing fibers and fibrils and/or a polymer modified cellulose material containing fibers and fibrils. In some embodiments, a biodegradable polymer is reinforced with a polymer modified cellulosic material containing fibers and fibrils and/or a polymer modified cellulose material containing fibers and fibrils.

In some embodiments, a biodegradable polymer is or comprises poly-β-hydroxybutyrate-co-β-hydroxy valerate (PHBV), polyglycolic acid (PGA), poly(lactic) acid (PLA), poly (ε-caprolactone) (PCL), nylon-2-nylon-6, and/or polybutylene adipate terephthalate (PBAT).

### Reinforced Composites

In accordance with various embodiments, the present disclosure encompasses a recognition that certain parameters and/or processes may be advantageous for creating composites (e.g., biodegradable composites) comprising a polymer modified cellulosic material containing fibers and fibrils and/or a polymer modified cellulose material containing fibers and fibrils, and a matrix polymer. In some embodiments, a composite is reinforced according to methods described herein.

### Compositions

In some embodiments, a composite comprises a cellulosic material comprising one or more reactive functional groups or handles, one or more water soluble polymers, and a matrix polymer. In some embodiments, the amount of cellulosic material comprising one or more reactive functional groups or handles and one or more water soluble polymers in the composite is between about 3% and about 50% by weight of the composite.

In some embodiments, a composite comprises a cellulosic material comprising one or more reactive functional groups or handles, one or more water insoluble polymers, and a matrix polymer. In some embodiments, the amount of cellulosic material comprising one or more reactive functional groups or handles and one or more water insoluble polymers in the composite is between about 3% and about 50% by weight of the composite.

In some embodiments, a composite comprises a cellulosic material comprising an acrylate ester moiety and at least one polymer selected from a group consisting of an acrylate ester polymer, an acrylic acid polymer, an acrylamide polymer, a styrene polymer, a diene polymer, a vinyl ether polymer and/or a vinyl acetate polymer, and a matrix polymer. In some embodiments, the amount of cellulosic material comprising an acrylate ester moiety and at least one polymer selected from a group consisting of an acrylate ester polymer, an acrylic acid polymer, an acrylamide polymer, a styrene polymer, a diene polymer, a vinyl ether polymer and/or a vinyl acetate polymer in the composite is between about 3% and about 50% by weight of the composite.

In some embodiments, a composite comprises a cellulose containing fibers and fibrils comprising one or more reactive functional groups or handles, one or more water soluble polymers, and a matrix polymer. In some embodiments, the amount of cellulose containing fibers and fibrils comprising one or more reactive functional groups or handles and one or more water soluble polymers in the composite is between about 3% and about 50% by weight of the composite.

In some embodiments, a composite comprises a cellulose containing fibers and fibrils comprising one or more reactive functional groups or handles, one or more water insoluble polymers, and a matrix polymer. In some embodiments, the amount of cellulose containing fibers and fibrils comprising one or more reactive functional groups or handles and one or more water insoluble polymers in the composite is between about 3% and about 50% by weight of the composite.

In some embodiments, a composite comprises a cellulose containing fibers and fibrils comprising an acrylate ester moiety and at least one polymer selected from a group consisting of an acrylate ester polymer, an acrylic acid polymer, an acrylamide polymer, a styrene polymer, a diene polymer, a vinyl ether polymer and/or a vinyl acetate polymer, and a matrix polymer. In some embodiments, the amount of cellulose containing fibers and fibrils comprising an acrylate ester moiety and at least one polymer selected from a group consisting of an acrylate ester polymer, an acrylic acid polymer, an acrylamide polymer, a styrene polymer, a diene polymer, a vinyl ether polymer and/or a vinyl acetate polymer in the composite is between about 3% and about 50% by weight of the composite.

In some embodiments, a composite comprises a modified cellulose nanofibril material comprising an acrylate ester moiety and at least one polymer selected from a group consisting of an acrylate ester polymer, an acrylic acid polymer, an acrylamide polymer, a styrene polymer, a diene polymer, a vinyl ether polymer and/or a vinyl acetate polymer, and a matrix polymer. In some embodiments, the amount of modified cellulose nanofibril material in the composite is between about 3% and about 50% by weight of the composite.

In some embodiments, a composite comprises a polymer modified cellulosic material containing fibers and fibrils. In some embodiments, a reinforced composite comprises a polymer modified cellulosic material containing fibers and fibrils and a matrix polymer. In some embodiments, the amount of polymer modified cellulosic material containing fibers and fibrils in the reinforced composite is between about 3% and about 50% by weight of the composite.

In some embodiments, a composite comprises a polymer modified cellulose material containing fibers and fibrils. In some embodiments, a reinforced composite comprises a polymer modified cellulose material containing fibers and fibrils and a matrix polymer. In some embodiments, the amount of polymer modified cellulose material containing fibers and fibrils in the reinforced composite is between about 3% and about 50% by weight of the composite.

In some embodiments, a composite comprises a polymer modified cellulosic material containing fibers and fibrils and poly(lactic) acid (PLA). In some embodiments, the amount of polymer modified cellulosic material containing fibers and fibrils in the composite is between about 3% and about 50% by weight of the composite.

In some embodiments, a composite comprises a polymer modified cellulose material containing fibers and fibrils and poly(lactic) acid (PLA). In some embodiments, the amount of polymer modified cellulose material containing fibers and fibrils in the composite is between about 3% and about 50% by weight of the composite.

In some embodiments, a composite comprises a polymer modified cellulose nanofibril and poly(lactic) acid (PLA). In some embodiments, the amount of polymer modified cellulose nanofibril in the composite is between about 3% and about 50% by weight of the composite.

### Characterization of Reinforced Composites

A composite material produced according to a method, as described herein, may have one or more enhanced properties.

In some embodiments, a provided composite is characterized as having an impact resistance that is higher than that of a composite consisting of only the matrix polymer and an unmodified cellulose material (i.e., neat cellulose material). In some embodiments, provided compositions are characterized as having an impact resistance at least 5% (e.g., 6%, 7%, 8%, 9%, 10%, 15%, 20%, 25%, 30%, 35%, 40%, 45%, or 50%) higher than that of a composite consisting of only the matrix polymer and an unmodified cellulose material (i.e., neat cellulose material).

In some embodiments, a provided composite is characterized as having a tensile modulus of elasticity that is higher than that of a composite consisting of only the matrix polymer and an unmodified cellulose material (i.e., neat cellulose material). In some embodiments, provided compositions are characterized as having a tensile modulus of elasticity at least 5% (e.g., 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 105%, 110%, 115%, or 120%) higher than that of a composite consisting of only the matrix polymer and an unmodified cellulose material (i.e., neat cellulose material). In some embodiments, provided composite materials may exhibit increased tensile modulus elasticity as compared to a composite consisting of only the matrix polymer and an unmodified cellulose material (i.e., neat cellulose material) while maintaining a level of impact resistance at or above the impact resistance exhibited by the composite consisting of only the matrix polymer and an unmodified cellulose material (i.e., neat cellulose material).

In some embodiments, a provided composite is characterized as having a tensile strength that is higher than that of a composite consisting of only the matrix polymer and an unmodified cellulose material (i.e., neat cellulose material). In some embodiments, provided compositions are characterized as having a tensile strength at least 5% (e.g., 6%, 7%, 8%, 9%, 10%, 15%, 20%, 25%, 30%, 35%, 40%, 45%, or 50%) higher than that of a composite consisting of only the matrix polymer and an unmodified cellulose material (i.e., neat cellulose material). In some embodiments, provided composite materials may exhibit increased tensile strength as compared to a composite consisting of only the matrix polymer and an unmodified cellulose material (i.e., neat cellulose material) while maintaining a level of impact resistance at or above the impact resistance exhibited by the composite consisting of only the matrix polymer and an unmodified cellulose material (i.e., neat cellulose material).

In some embodiments, a provided composite is characterized as having a flexural modulus of elasticity that is higher than that of a composite consisting of only the matrix polymer and an unmodified cellulose material (i.e., neat cellulose material). In some embodiments, provided compositions are characterized as having a flexural modulus of elasticity at least 5% (e.g., 6%, 7%, 8%, 9%, 10%, 15%, 20%, 25%, 30%, 35%, 40%, 45%, 50%, 55%, 60%, 65%, 70%, 75%, 80%, 85%, 90%, 95%, or 100%) higher than that of a composite consisting of only the matrix polymer and an unmodified cellulose material (i.e., neat cellulose material). In some embodiments, provided composite materials may exhibit increased flexural modulus elasticity as compared to a composite consisting of only the matrix polymer and an unmodified cellulose material (i.e., neat cellulose material) while maintaining a level of impact resistance at or above the impact resistance exhibited by the composite consisting of only the matrix polymer and an unmodified cellulose material (i.e., neat cellulose material).

In some embodiments, a provided composite is characterized as having a flexural strength that is higher than that of a composite consisting of only the matrix polymer and an unmodified cellulose material (i.e., neat cellulose material). In some embodiments, provided compositions are characterized as having a flexural strength at least 5% (e.g., 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 105%, 110%, 115%, or 120%) higher than that of a composite consisting of only the matrix polymer and an unmodified cellulose material (i.e., neat cellulose material). In some embodiments, provided composite materials may exhibit increased flexural strength as compared to a composite consisting of only the matrix polymer and an unmodified cellulose material (i.e., neat cellulose material) while maintaining a level of impact resistance at or above the impact resistance exhibited by the composite consisting of only the matrix polymer and an unmodified cellulose material (i.e., neat cellulose material).

### Additive Manufacturing

Additive manufacturing, or 3D printing, is an important manufacturing tool in a number of industries. These processes are moving from the benchtop and to the manufacturing floor via developments in tooling and printing techniques, which have enabled large-scale additive manufacturing (LSAM). Traditionally, LSAM, carried out through fused deposition modeling (FDM) or 3D printing, has relied upon acrylonitrile butadiene styrene (ABS), often reinforced with carbon fiber, because of its robust mechanical properties and ease of printing. The increasing utilization of petroleum-derived polymers like ABS in other applications has led to the buildup of persistent plastic waste in landfills and the environment

Wood flour/PLA composites are already in commercial use, but show diminished mechanical properties relative to neat PLA (see, e.g., Kain, S., et al. “Effects of the infill pattern on mechanical properties of fused layer modeling (FLM) 3D printed wood/polylactic acid (PLA) composites.” European journal of wood and wood products 78 (2020): 65-74; and Ecker, J V., et al. “Mechanical properties and water absorption behaviour of PLA and PLA/wood composites prepared by 3D printing and injection moulding.” Rapid Prototyping Journal 25.4 (2019): 672-678).

In accordance with various embodiments, provided technologies display certain advantages and/or solve one or more problems associated with prior technologies. In some certain embodiments, the present disclosure provides methods that are applicability to many technological fields and industries. For example, in some embodiments, methods provided herein may produce any of a variety of composites (e.g., poly(lactic) acid (PLA) composites) suitable for inter alia, 3d printing.

In some embodiments, composites, as described herein, exhibit tensile properties comparable to solvent cast systems while employing only commercially available spray drying and melt extrusion techniques.

In some embodiments, composites, as described herein, may be used in variety of molding techniques (e.g., thermoplastic molding technique e.g., rotomolding, blow molding, injection molding, vacuum molding).

### EXEMPLIFICATION

### Example 1: Methacrylation and Grafting-Through Polymerization of Wood Pulp

The present example demonstrates that methacrylation and grafting-through polymerization may facilitate fibrillation (e.g., mechanical fibrillation) of wood pulp fibers with reduced energy consumption.

### Materials & Methods

### Synthesis and Scale Up

Methacrylic anhydride, 94%, stabilized with 0.2% 2,4-dimethyl-6-tert-butylphenol and methyl methacrylate (MMA) (99%, stabilized) were purchased from Thermo Scientific Chemicals. Acrylamide (AM) Certified ACS, potassium persulfate (KPS) (Certified ACS≥99%), and sodium hydroxide (NaOH) pellets (≥97.0%) were received from Fisher Scientific. All the chemicals were used without further purification.

Northern bleached softwood kraft pulp (BSKP) was utilized. This pulp was bleached through a typical chlorine dioxide process and has approximately 78% cellulose, 19% hemicelluloses, and less than 3% lignin.

### Surface Modification

A base-activated titration method was used to modify a BSKP surface through a reaction with methacrylic anhydride at a molar ratio of about 20.7:1 of methacrylic anhydride:cellobiose in the presence of NaOH. A 0.5 wt % BSKP aqueous suspension was mixed with the methacrylic anhydride. The mixture was then titrated with 10.0 M NaOH solution until the pH value was stable in the range of 9.5-10.5. The reaction was allowed to stir for 2 h at room temperature with pH monitoring. Then, methacrylated BSKP (Met-BSKP) was collected by vacuum filtration and washed with reverse osmosis (RO) water for six cycles. Attenuated total reflectance Fourier transform infrared spectroscopy (ATR-FTIR) measurements were carried out to determine the success of methacrylation; a newly formed band at ~1720 cm-1 (ester C═O) confirmed the presence of methacrylate groups.

Next, Met-BSKP was copolymerized with hydrophilic acrylamide (AM) and hydrophobic methyl methacrylate (MMA) monomers using KPS as the initiator. BSKP-AM was synthesized by a solution polymerization with a molar ratio of about 6:1 of monomer:cellobiose. A suspension of Met-BSKP (0.5 wt %) was mixed with AM monomer and deoxygenized by sparging with nitrogen gas for 45 min. Then, the mixture was heated to 70° C., and an equivalent of 0.68:1 molar ratio of initiator:cellobiose was injected from 0.09 M KPS stock solution. The polymerization was allowed to proceed for 2 h, after which it was stopped by exposing the reaction mixture to air. For BSKP-PMMA preparation, a surfactant-free emulsion polymerization method was used. The monomer:cellobiose:KPS molar ratio of about 12.5:1:0.065 was employed. After deoxygenizing the Met-BSKP suspension by nitrogen sparging for 45 min and heating to 70° C., MMA monomer was added first followed by KPS injection. The polymerization was carried out for 2 h while being agitated with an overhead stirrer. All samples were extensively washed with RO water six times.

BSKP modifications were scaled up to produce around 1.0 kg solid of the modified BSKP material using a 100 L process reactor system with a 400 mm flange from Chemglass Life Sciences LLC. The temperature of the scale-up reactions was controlled by Huber Unistat 410 dynamic temperature control system. The sample was purified using 320 mm filter press from MW Watermark LLC and washed with RO-water for six washing/filtration cycles. The sample did not completely dry (~6 wt %) and was stored in refrigerator.

### Met-CNF Modification

The methacrylated pulp fibers after fibrillation (Met-CNFs) were modified by AM and MMA. A 0.5 wt % of Met-CNF suspension was used with a monomer:cellobiose:KPS molar ratio of 6:1:0.68 and 12.5:1:0.065 for AM and MMA copolymerization modification reaction, respectively. The polymerization was carried out after deoxygenizing the Met-CNF suspension by nitrogen sparging for 45 min and heating to 70° C., monomer was added first followed by KPS injection. The polymerization was carried out for 2 h while being agitated with strong overhead stirrer. All samples were extensively washed, and vacuum filtrated with RO water for six cycles.

### Mechanical Fibrillation

The unmodified and modified BSKP samples were fibrillated as a water suspension using a Supermass Colloider (Model: MKCA6-2, Masuko Sangyo Co. Ltd., Japan) at 2000 rpm. The SMC had a power meter that captured the amount of electrical energy input. Two stone grinding disks were arranged, with one placed on top of the other. The bottom disk rotated while the upper one remained stationary. Gravity was used in the BSKP sample feeding process without applying any external hydraulic pressure. Before loading the pulp, the correct position for motion zero was established when the two grinding disks made contact. When BSKP sample was present, the two grinding stones did not have direct contact. BSKP suspension was continuously recycled and supplied to the disk grinder via a peristaltic loop consisting of a SEEPEX pump (Type: BN 5-6LS) and a stainless-steel tubing system. Initially, sample suspension (2.2 wt %) was added to the circulation unit of the fibrillation system. All the fibrillation units were in active mode with a rotation speed of the fibrillation disk was 2000 rpm. At this step, there was no load added to the sample by the system, and the space between the abrasive disks was ample for the free moving of the sample suspension through the system. After 20 min of conditioning, an extra load was added to the system by decreasing the distance between the abrasive disks to start the fibrillation and monitoring the system's net cumulative energy (NCE). Morfi measurements were conducted on fibrillated BSKP samples at regular intervals, while time-dependent energy consumption was recorded using the power meter. NCE calculated according to Equation 1.

$$NCE = {\sum }_{i = 0}^{n} \frac{( {P}_{n} - {P}_{0} ) \cdot ( {t}_{n} - {t}_{n - 1} )}{W} \qquad Equation 1$$

Where, Pₙ is the interval power (kw), P₀ the power with no load applied (kw), tₙ the interval total time (hr), and W is the total dry sample weight (MT).

### Attenuated Total Reflection Fourier Transform Infrared Spectroscopy (ATR-FTIR)

A Spectrum Two FT-IR Perkin Elmer with UATR sampling accessory was used to record the ATR-FTIR spectra with 10 scans in the wavenumber range of 450-4000 cm⁻¹ at a resolution of 1 cm⁻¹ using a diamond crystal attenuated total reflection accessory. ATR correction, i-baseline adjustment, and normalization of the 1055 cm⁻¹ band, corresponding to the C—O stretching mode from the cellulose backbone, were applied for all samples after each measurement.

### Optical Fiber Length Analysis

The term ‘fines’ encompasses particles that can pass through a 200-mesh screen with an aperture width of 76 μm, and the median size typically for the cellulose fibrils ranges from 17 to 50 μm in the mechanical pulping in the paper industry. A MorFi fiber analyzer (TECHPAP SAS) was employed to determine the percentage of fines of the fibers during the fibrillation of the BSKP samples (5000 fibers/measurement were analyzed). The software analyzed the resulting images and determined the fiber size according to optical length in the range of 100 μm-10 mm and optical width in the range of and 5 μm-75 μm. The analysis was performed on a diluted aqueous fibrous suspension to keep the fibers in a naturally unrestrained environment. The length and width distribution results were exported and transferred to Microsoft Excel software for more calculations.

### Standard Contrast Scanning Electron Microscopy (SEM)

Standard contrast SEM imaging was used for all dry samples. SEM was used to analyze the morphology of materials with a Zeiss NVision 40 FIB/SEM at an acceleration voltage of 3 kV. The dried samples were sprinkled onto carbon tape attached to the SEM stubs and then sputter-coated with gold/palladium alloy (Au/Pd 60/40%) by using Cressington 108 auto sputter coater in automatic operation, before SEM analysis. The sputtering process at the desired thickness of 6 nm was terminated by using a Cressington MTM-20 thickness controller under argon purge control.

### Negative Contrast SEM

Negative contrast SEM imaging was employed for all fibrillated samples in suspension. A CUBE Tabletop SEM (EMCRAFTS) was used at an acceleration voltage of 10 kV in fibers width analysis through unmodified and modified BSKP fibrillation. Silicon chip specimen supports (TedPella, Inc.) were placed on top of carbon tape attached to the SEM stubs and sputter-coated with Au/Pd (4 nm). Then, the samples were dropped cast while suspended in water (0.005 wt %) onto the sputter-coated specimens and air-dried overnight before SEM imaging. The image magnification was fixed at ×1000 with a working distance of 9.8 mm. The SEM images were analyzed via Image Processing and Analysis in Java (ImageJ, version 1.53 t). The distance in pixels was first converted to the unit of length in micrometers. Images were analyzed by overlaying a grid on top and measuring the diameter of each fiber that crossed through the grid. The Grid plugin area per point was set to 800 μm² for the grids. Fibers that crossed the grid at multiple discrete points were measured at each intersection, as the individual fibers and fibrils could not be separated across the entire image. The exported results were plotted and statistically analyzed by normal histogram using OriginPro 8.5.0 SR1 b161 software.

### Hard-to-Remove Water (HR Water)

High-resolution isothermal thermogravimetric analysis (TGA) measured “hard-to-remove (HR) water” in CNFs. An initial mass around 50 mg of 3 wt. % solids content of fibrillated unmodified and modified BSKP samples was prepared and tested using TGA (model Q500, TA Instruments, New Castle, DE, USA) with a heating regime of ramping up (80° C./min) to 120° C. and then continuing isothermally at 120° C. for 10 minutes to assure that samples are fully dried. In addition, post-fibrillation modified BSKP samples were also tested using the same method. The results were analyzed by TA Instruments Universal Analysis 2000 V. 4.5 A software.

The HR-water content was determined by analyzing the weight loss of the sample versus the time curve. The first derivative calculation was applied to the weight loss curve to determine the transition step between the constant water evaporation zone and the drop in the rate of the water evaporation zone in the heating process. Then, the second derivative curve showed in detail the beginning of the transition stage on the changes in the evaporative rate, which was used to find the corresponding weight of wet sample value at that point (W_{wet}) from the original TGA. The HR water value was then calculated by dividing the W_{wet} by the dry weight of the sample (W_{dry}) at the end of the TGA measurement (see, e.g., Equation 2).

$$HR water = \frac{{W}_{wet}}{{W}_{dry}} \qquad Equation 2$$

### Water Retention Value (WRV)

The water retention value (WRV) was measured for unmodified and modified BSKP before and after fibrillation using a two-step vacuum filtration and centrifugation method. A 100 mL sample at 1.5 wt % solid was filtered for 30 min using a Buchner filtration setup attached to a UN 86 KTP filtration pump with filter paper that was oven-dried (150° C.) overnight and weighed before filtration. Then, the filter paper with the filtered sample transferred to a centrifugation tube, leaving space for remaining water to accumulate at the bottom of the tube. Samples were centrifuged (Table Top Low-Speed Electric Medical Centrifuge, China) under 3000 rpm for 10 min. The filter paper with the filtered sample were oven-dried (150° C.) overnight. The samples were weighed before and after oven drying to determine WRV according to Equation 3.

$$WRV ( \% ) = \frac{{m}_{wet} - {m}_{od}}{{m}_{od}} \times 100 \% \qquad Equation 3$$

The m_{wet} and m_{od} are the mass of the sample before and after oven drying, respectively.

### Results

### BSKP Modification

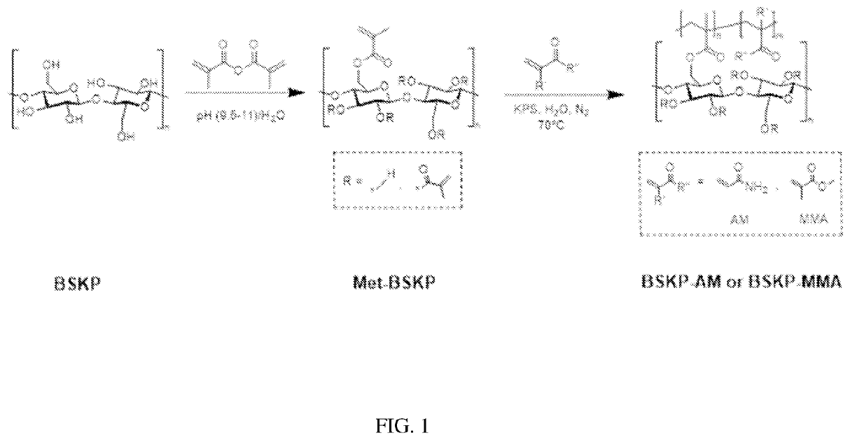

Methacrylic anhydride reacted with the cellulose hydroxyl groups to yield methacrylate groups that act as reactive handles for polymer grafting. Then, copolymerization of these Met-BSKP fibers was carried out with either AM or MMA monomers (see FIG. 1). For BSKP-AM and BSKP-MMA, we found the degree of functionalization, expressed as the repeat unit to cellobiose mole ratio, to be 1.00±0.33 and 0.37±0.23, respectively. Notably, the water-soluble monomer exhibited a similar degree of polymer functionalization on cellulose surfaces as observed in CNF modification. In contrast, the water-insoluble monomer displayed significantly lower functionalization compared to MMA-based CNF modification.

### Modified BSKP Fibrillation

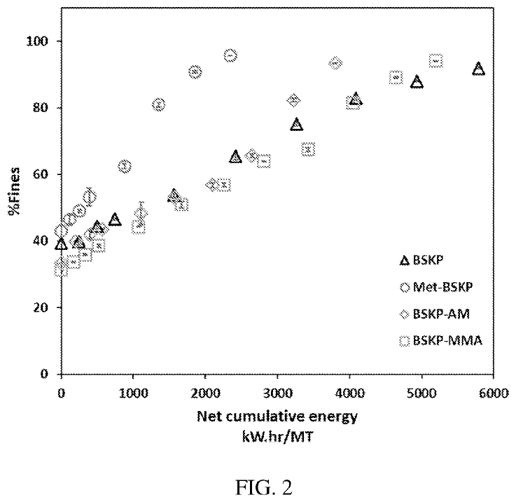

Samples were fibrillated using the SMC in water at 2,000 rpm and the energy added to the system to reach more than about 90% fines was monitored. FIG. 2 shows the net cumulative energy (NCE) applied by the SMC in the BSKP fibrillation process. Met-BSKP showed a reduction of NCE by about 68% at about 90.4 fine % compared with the energy needed to fibrillate the unmodified BSKP sample. In addition, BSKP-AM and BSKP-MMA had an about 34% and about 10% reduction in NCE, respectively.

Without wishing to be bound by any particular theory, these findings indicated that chemical modification applied to the BSKP may prevent hydrogen bonding, capillary forces, and entropy driven self-assembly that might cause the nanofibers to reaggregate. Furthermore, alteration of fiber surface chemistry significantly changed the fiber properties, consequently influencing the fibrillation process.

Multiple samples were collected from the SMC at distinct time points (0, 15, 45, and 75 minutes) to examine fiber shape and size alterations during the fibrillation process. A decrease in the fiber length of all samples was observed. All the samples reached an average fiber length in the lower detection range of the Morfi instrument (about 200-289 μm) at the end of the fibrillation process to produce a fibrillated CNF materials (unmodified CNF, Met-CNF, CNF-AM, and CNF-MMA).

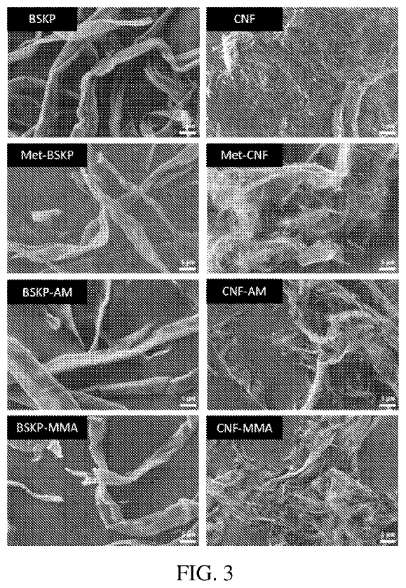

As shown in FIG. 3, SEM of the unmodified and polymer modified BSKP before fibrillation showed the presence of liberated microfibrils and the roughened surface of the larger pulp fibers. During fibrillation, the microfibrils were peeled off the surface of the larger fibers and produced a new fiber distribution and more surface area. Following a 75-minute fibrillation period, the modified BSKP samples exhibited a significantly narrower distribution of fiber widths. Met-BSKP, BSKP-AM and BSKP-MMA recorded measurements of about 1.4±0.6 μm, about 0.5±0.3 μm, and about 1.6±0.9 μm, respectively, while the unmodified BSKP measured at about 2.2±0.9 μm. Notably, the BSKP-AM and BSKP-MMA samples demonstrated a substantial reduction in fiber width within the first 15 minutes of fibrillation.

### Fiber-Water Interactions

The water retention value (WRV) may determine the amount of water a cellulose material can retain against a defined external force. For example, the cellulose fiber's capacity to absorb, control, and desorb moisture under varying conditions. The WRV value depends directly on the surface area and the abundance of hydroxyl groups on the material that readily form hydrogen bonds with water molecules, which makes it a proxy measurement for extent of fibrillation as well.

Determining the water retention characteristics of the BSKP materials involved systematically quantifying the WRV indices for the BSKP samples pre- and post-fibrillation. The WRV measurements focused on the capacity of the original and fibrillated BSKP materials to hold water under vacuum filtration and centrifugal force. The techniques employed simulated diverse mechanisms of water removal, thereby providing information regarding the extent of fibrillation of the samples.

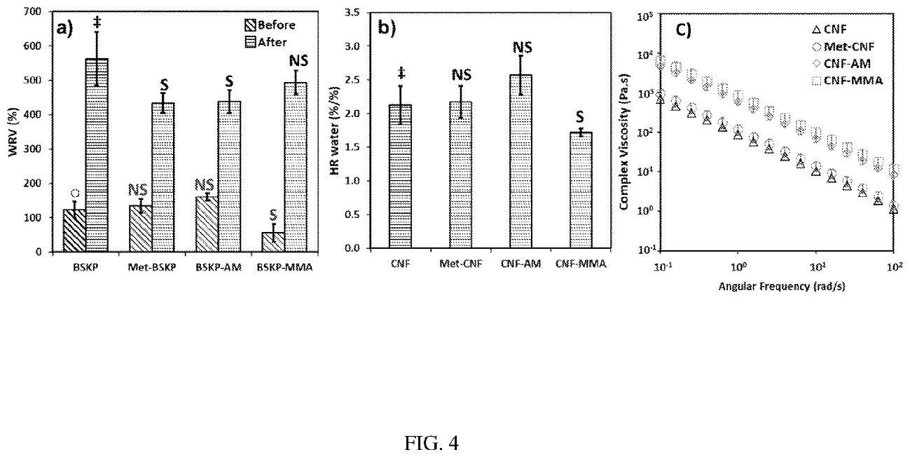

The modification of BSKP affected the WRV due to the presence of the new functional groups on the surface of the pulp fiber (see FIG. 4, panel A). The incorporation of the hydrophilic polymer (PAM) on the BSKP increased the WRV. Conversely, PMMA resulted in a significant decline in the WRV of the sample. The WRV increased for all samples after fibrillation due to the significant enhancement of the surface area of the samples through the refinement to smaller fibers and fibrils. This WRV increase indicated that fibrillation occurred for all samples to generate more hydroxyl groups that hold water molecules. All the modified samples after fibrillation had a lower WRV than the unmodified sample due to decreased number of hydroxyl groups sites on the surface of the fibers. In addition, this result could be due to the chemical modification causing the fibrils to flocculate allowing the water to drain quickly through generated channels. The results suggested that the surface modifications significantly reduced the WRV of the fibrillated samples especially of Met-CNF and CNF-AM (P<0.05).

Hard-to-Remove Water (HR-water) describes the water embedded within the fibers and fibrils that resist typical removal methods due to its interactions with the cellulose surface. HR-water and its behavior can significantly impact materials' physical properties and performance, particularly in paper and pulp processing. It becomes particularly relevant in processes like thermal pressing and dewatering, where water removal is crucial in achieving the desired material properties. HR-water values of the modified CNF samples depended on the modification on the surface of the CNFs (see FIG. 4, panel B). The Met-CNFs showed relatively the same HR-water values as the unmodified CNF, whereby adding more hydrophilic polymer (PAM) insignificantly increased the HR-water compared with the unmodified CNF. The CNF-MMA had a significantly (p<0.05) lower HR-water due to the presence of hydrophobic grafted polymer (PMMA) on the surface of the fibers disrupting the interaction of water with the cellulose hydroxyl groups.

The rheological behavior of the modified CNF suspensions were characterized (see FIG. 3C). Notably, both polymer-modified samples demonstrated an overall increase in dynamic viscosity compared to the unmodified CNFs. The attachment of the polymers to the CNF surface increases the viscosity of the solution, which consequently reduces their WRV values. Flocculation of CNFs through modification has reduced WRV and dewatering time of CNF suspensions by creating larger pores in the CNF mesh that aid in water transport (see, e.g., Fein K, Bousfield D W, Gramlich W M (2020) The influence of versatile thiol-norbornene modifications to cellulose nanofibers on rheology and film properties. Carbohydr Polym 230:115672.)

### Modification of Met-CNF

After fibrillation, the presence of the methacrylate functional group on the Met-BSKP fibers allowed for additional modification of the generated Met-CNF using the same grafting-through polymerization process.

ATR-FTIR results confirmed the polymer grafting on the Met-CNF surface. New peaks correlated with the presence of AM appeared in the spectra at 1660 cm⁻¹ for the amide C—O group. The normalized absorbance intensity value was the same as the CNF-AM sample. For the Met-CNF-MMA material, the normalized intensity value of the ester C—O functional group at ~1720 cm⁻¹ significantly increased as compared with the CNF-MMA.

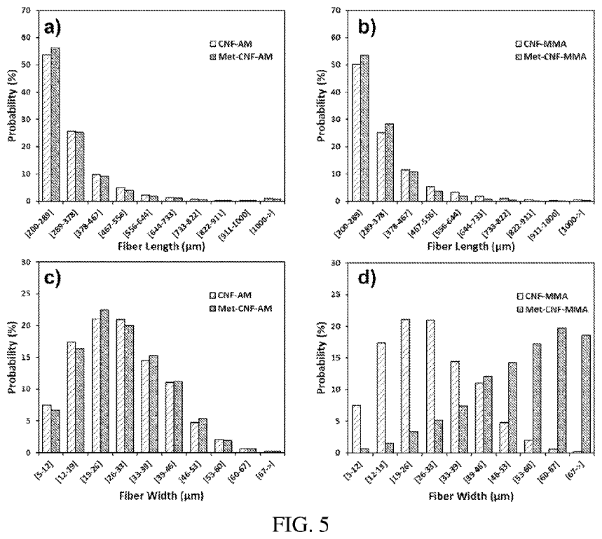

The surfactant-free emulsion copolymerization of MMA was affected by the fibers smaller size and greater surface area compared to the pulp. CNFs are well-known for their ability to act as an effective emulsifier and generate stable Pickering emulsions. Therefore, the Met-CNF-MMA had more PMMA grafted on the surface of the cellulose fibers than the CNF-MMA made from BSKP-MMA. The increased degree of grafting affected the physical and chemical properties of the modified Met-CNF. The % fines of the Met-CNF after modification with PMMA decreased from 95% to 82% and the optical images indicated agglomeration of the fibers. The increase of the grafting with PMMA clearly changed the texture of the material and made the solid filter cake spongier. The Morfi analysis results had the same fiber length distribution between the polymer modified samples (see FIG. 5, panel A and B). Additionally, the fiber width distribution of the CNFs for both PAM modification paths had similar results, which indicates that since the soluble monomer grafting polymerization leads to a similar final degree of functionalization, it does not affect the morphology of the material. However, due to the agglomeration of the Met-CNF-MMA particles, the average value of the fiber width distribution was significantly higher than the CNF-MMA because of the change of the degree of functionalization (see FIG. 4, panel C and D). A higher concentration of MMA on the CNF surface led to the formation of monomer swollen polymer particles, which subsequently intertwined within the fibril network during the synthesis process and caused the hydrophobic CNFs to collapse on themselves.

Met-CNF-AM and Met-CNF-MMA were freeze-dried from the aqueous suspension and dispersed on a carbon tape. The sample with MMA exhibited substantial macroscopic aggregation of CNF fibrils, in comparison with the AM sample. In addition, the impact of the addition of PAM and PMMA on the Met-CNFs, the WRV and HR-water were also measured to compare with modified BSKP before and after fibrillation. The modification of Met-CNFs through aqueous polymerization using AM resulted in a slight increase in WRV and significant increase in HR-water properties. Conversely, the modification of Met-CNFs with PMMA increased the hydrophobic polymer on the surface, which reduced the interaction with water molecules and consequently decreased in WRV and significantly reduced in HR-water value (p<0.01).

### Discussion

Methacrylation and grafting-through polymerization facilitated mechanical fibrillation of BSKP fibers to produce CNFs with substantially reduced energy consumption using disk refining in a SMC. Energy savings for mechanical fibrillation were noticeable, especially for Met-BSKP, with about 68% energy reduction for about 90% fine as compared with the unmodified BSKP. The produced CNFs had similar microstructure regardless of the modification performed. The polymer modification could be performed before or after fibrillation to yield distinct modification routes and CNFs with different water interaction properties. These modifications could notably ease the compatibilization process with polymer matrices, such as PLA.

### Example 2: High Strength Additive Manufactured Poly (Lactic Acid) Composites Reinforced by Polymer Grafted Cellulose Nanofibrils (CNFs)

The present example demonstrates that aqueous polymer grafting through modification of Cellulose Nanofibrils (CNFs) may produce improved 3D printed Poly (Lactic Acid) (PLA) composites.

### Materials & Methods

### Synthesis and Scale Up

CNFs used in this study were purchased from the Product Development Center at the University of Maine and provided as a 3.3 wt. % suspension in water. These CNFs were produced by mechanical refinement to a fines content of 90% by length. The morphology and chemical composition of tested materials exhibit a hierarchical branching structure with fibrils spanning orders of magnitude in width and length. N-isopropylacrylamide (NIPAM) 99% pure, stabilized, methacrylamide (MAM) 98% extra pure, ammonium persulfate (APS) 98+% pure were purchased from Thermo Fisher Chemicals. Certified ACS potassium persulfate (KPS) and sodium hydroxide (NaOH) pellets were purchased from Fisher Scientific. N,N,N′,N′-tetramethylenediamine 98.0+% was purchased from TCI America. All chemicals were used as received. Ingeo™ Biopolymer 4043D PLA pellets were purchased from NatureWorks (Plymouth, MN) and used for compounding and 3D printing.

Methacrylated CNFs (MetCNFs) was prepared a large scale (i.e. at least 100 L). Batches of 0.5 kg CNFs on a dry basis were dispersed to 0.5 wt. % with reverse osmosis water in a 100 L jacketed glass reactor purchased from Chemglass Life Sciences (Vineland, NJ). Methacrylic anhydride was added to reach a final concentration of 0.6 M, at which point the reaction was titrated with 10 M NaOH for 2 hours, keeping the suspension pH between 9 and 11. Upon completion of the reaction the suspension was filtered using a W.M. Watermark (Holland, MI) 320 mm filter press, with subsequent resuspension and filtration cycles being performed until FTIR analysis of MetCNF aliquots showed no change in the bands associated with the surface methacrylate at 1720 cm-1 or any side products. In total about five washes were required to purify the product.

Poly (N-isopropylacrylamide) modified CNFs (PNIPAM-MetCNFs) and poly(methacrylamide) modified CNFs (PMAM-MetCNFs) were also prepared at a large scale (i.e. at least 100 L). Three batches of each synthesis were performed to achieve the amount of material required for compounding and 3D printing. The PMAM-MetCNF syntheses were carried out with a monomer concentration of 88 mM, 0.5 wt. % MetCNF suspensions, and approximately 60 L of total volume. The system was sparged for 90 minutes with nitrogen and heated to 70° C. using a Huber (Offenburg, Germany) Unistat 410 temperature control system attached to the reactor's glass jacket before a 0.129 M KPS stock solution was added to reach a final concentration of 10 mM. The PNIPAM-MetCNF syntheses were performed with the same monomer concentration (i.e. 88 mM), MetCNF solids content (i.e. 0.5 wt. %), and total reaction volume (i.e. 60 L) as the PMAM-MetCNF scale up, but were performed at room temperature using a redox initiator system. After 90 min of sparging with nitrogen 0.6 M APS and TEMED stock solutions were added to achieve final concentrations of 9.6 mM. Both sets of reactions were run for 3 hours at which point the suspensions were collected and purified via subsequent washing cycles using the W.M. Watermark 320 mm filter press. FTIR aliquots were taken after each wash to verify when unattached homopolymer was fully removed, which took about three washes.

### Suspension Characterization

Attenuated total reflectance Fourier transform infrared spectroscopy (ATR-FTIR) was used to analyze the surface modification of the CNFs. Suspensions were freeze dried prior to analysis and scanned from 4000 cm-1 to 450 cm-1 with a resolution of 4 cm-1 using a Perkin Elmer (Waltham, MA, USA) Spectrum Two. The instrument averaged 8 scans which were then worked up using an ATR correction, manual baselining, and normalization to the 1055 cm⁻¹ band.

### Spray Drying of CNFs and Powder Characterization

Drying of the polymer modified CNF suspensions was carried out using a scale spray dryer (GEA-Niro, Germany). Suspensions were diluted to 1 wt. %. and sprayed onto a spinning disk atomizer operating at 30,000 RPM with an inlet gas temperature of 235° C. and an outlet temperature of approximately 120° C. Dried powder was collected from the cyclone filter.

Imaging of the spray dried reinforcements was done using a Cube-II tabletop SEM (EmCrafts Co. LtD. Hanam, South Korea). Samples were dispersed over graphite tape and sputter coated with 6 nm of Au/Pd allow (60:40) to facilitate imaging. An acceleration voltage of 10 kV and a working distance of approximately 10 mm was used.

### Reinforcement Compounding

Small-scale melt mixing was performed on an Intelli-Torque Plasti-Corder half-size mixer (C.W. Brabender Instruments, NJ, USA). PLA pellets and spray-dried reinforcements were kept overnight in a vacuum oven at 50° C. before melt mixing to ensure low moisture content. The two heating zones were set at 175° C. with a mixing speed of 60 RPM. Neat PLA pellets were added first and allowed to equilibrate to the mixer temperature for approximately 2 minutes before the addition of reinforcements, which were mixed for an additional 5 minutes, at which point the torque had stabilized.

Large scale melt mixing of the composite materials for 3D printing was carried using a 2SE 27 MAXX (Leistritz Advanced Technologies Corp, Allendale, NJ) twin screw extruder at Oak Ridge National Laboratory. PLA and reinforcements were dried overnight at 60° C. before compounding. The twelve temperature zones were set to 145, 150, 155, 160, 165, 170, 180, 190, 185, 185, 185, and 185° C. respectively down the working range of the extruder. To achieve the desired composite composition PLA was fed gravimetrically at 8 kg/hr and reinforcements were added via a side stuffer at 2 kg/hr. The screw speed was set at 126 RPM and a vacuum was pulled at the halfway point between CNF addition and the outlet to remove residual moisture. Extrudate was pelletized to facilitate 3D printing.

### Compression Molding

Compression molding of composites was done using a Qixing (Wuhan, CN) Laboratory Mini Hot Press. Test samples were produced in a two-step process with an initial sheet of composite being pressed, cut into strips, and placed on top of molds before a final press. Plates were heated to 175° C., the composites were allowed to equilibrate without pressure for 5 minutes, and a press at 5 MPa for 5 minutes was used to mold the samples in both pressing steps. Water cooling was used at the end to quickly bring the composites down to room temperature. Tensile testing samples were type 5 dog bones conforming to ASTM standard D638-14 with gauge lengths of 7.62 mm, widths of 3.2 mm, and thicknesses of approximately 3.2 mm. Dynamic mechanical analysis (DMA) samples were 55 mm×3.6 mm×13 mm coupons.

### 3D Printing of Composites

Extrusion based 3D printing studies were performed using a Tradesman Series™ P3-44 system (JuggerBot 3D, OH) equipped with a 4 mm nozzle. Triangular prisms composed of three 127×141 mm faces were printed with a 6 mm wide, 1.5 mm tall bead profile. An appropriate screw RPM for each material was determined that would achieve this bead profile, generally between 9 and 10 RPM. Band heater temperatures were adjusted throughout the print to keep the temperature measured in the melt at approximately 165° C. The bed temperature and chamber temperature were kept constant at 65° C. and 40° C. respectively. The feed rate of the material was 850 mm/min for all prints except for neat PLA which required 600 mm/min to avoid the delamination of beads from the underlying layer during the print. Type 5 tensile bars and DMA bars were milled to the same dimensions as compression molded samples from the faces of the triangular prisms in both the x direction and z direction to explore anisotropy in the printed composites.

### Composite Characterization

Tensile testing of the composite samples was conducted on a Model 5966 electromechanical (Instron, Norwood, MA) equipped with a 10 kN Model 2580 load cell, Model 2716-015 mechanical grips, and a model 2630-121 clip-on extensometer. Testing was performed at a crosshead speed of 1 mm/min following ASTM standard D638. All tensile samples were aged in a conditioning chamber at 23° C., 50% relative humidity, for at least 40 hours before testing in accordance with ASTM standard D618. The strain measurements of x directional tensile bars and compression molded samples were conducted as noted above with extensometer removal at 0.007 mm/mm. Z-directional tensile samples failed earlier and as such extensometer removal was done at 0.003 mm/mm and Young's modulus was evaluated from start to 0.003 mm/mm.

Rheological behavior of composite samples and the neat PLA control were studied using a TA Instruments DHR-3 rheometer. Oscillatory shear tests were conducted in the linear viscoelastic region of the samples using an 8 mm parallel plate geometry, testing 5 frequencies per decade between 0.1 rad/s and 100 rad/s. Samples for tests were prepared by compression molding following the same procedure above. The rheological experiments were performed at 200° C. under nitrogen atmosphere to prevent oxidative degradation of the samples.

Differential scanning calorimetry (DSC) measurements were conducted on a DSC2500 instrument (TA Instruments, New Castle, DE). Approximately 10 mg of composite was weighed out into a TA Instruments TZero pan and sealed hermetically. Samples were subjected to a heat-cool-heat cycle with the following steps; a first heating cycle from 20° C. to 200° C. at 5° C./min, an isothermal hold at 200° C. for 5 min, a cooling cycle from 200° C. to 20° C. at 5° C./min, an additional isothermal hold at 20° C. for 5 min, with a second heating cycle from 20° C. to 200° C.

The percent crystallinity (X_{C}) of the tensile bars and extruded pellets was calculated using Equation 4 with the enthalpy of melting (ΔHₘ) and the enthalpy of cold crystallization (ΔHₘ) obtained from the first heating cycle. The enthalpy of melting for an infinite PLA crystal (ΔH_{∞}) was taken from literature as 93 J/g.

$${X}_{C} = \frac{( Δ {H}_{m} - Δ {H}_{cc} )}{( 1 - {m}_{f} ) Δ {H}_{∞}} \times 100 \qquad Equation 4$$

Dynamic mechanical analysis (DMA) testing was conducted on a TA Instruments Discovery DMA850 equipped with an AC3 cooling unit. Measurements were conducted using a dual-cantilever setup with a testing length of 35 mm. Samples were equilibrated at 20° C. for 2 minutes before testing. Temperature sweeps were performed in the linear viscoelastic region with a strain of 0.01% and a frequency of 1 Hz from 20° C. to 120° C. with a temperature ramp of 3° C./min. Three glass transition temperatures were determined for each sample using the onset point at which storage modulus began to drop, the peak of the loss moduli, and the peak of the tan delta value.

Size exclusion chromatography (SEC) was performed on an Agilent 1260 Infinity with three Phenogel (Phenomenex) columns of increasing pore size from 50 to 103 to 106 Å to study how the molecular weight of the PLA matrix changed during processing. Samples were dissolved in THF at approximately 4 mg/mL and filtered through a 0.22 μm filter before injection. The flow rate of the instrument was 1 mL/min, the column was held at 35° C., and the refractive index detector was kept at 35° C. Polystyrene standards were used for calibration.

Fracture surface analysis was done using a Zeiss (Oberkochen, Germany) NVision 40 FIB/SEM. Samples were mounted on graphite tape and sputter coated with a 6 nm film of 60:40 Au/Pd alloy. Imaging was done at an acceleration voltage of 3 kV to avoid melting the PLA and a working distance of approximately 4.5 mm.

### Results

### Modified Fibril Synthesis and Characterization

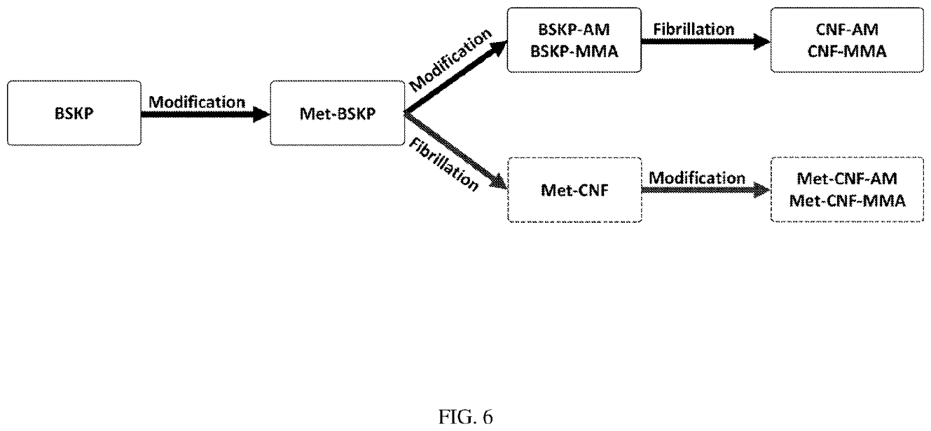

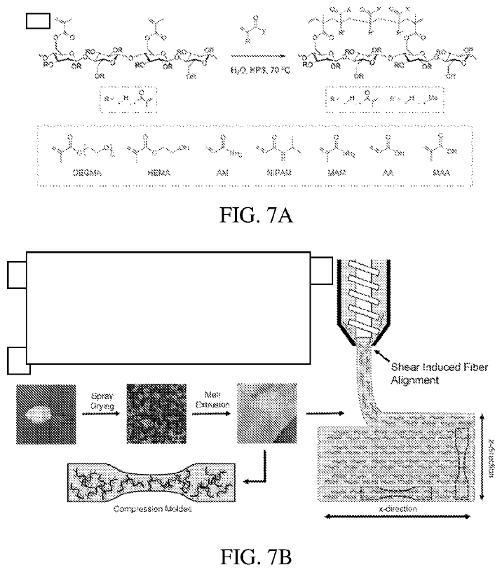

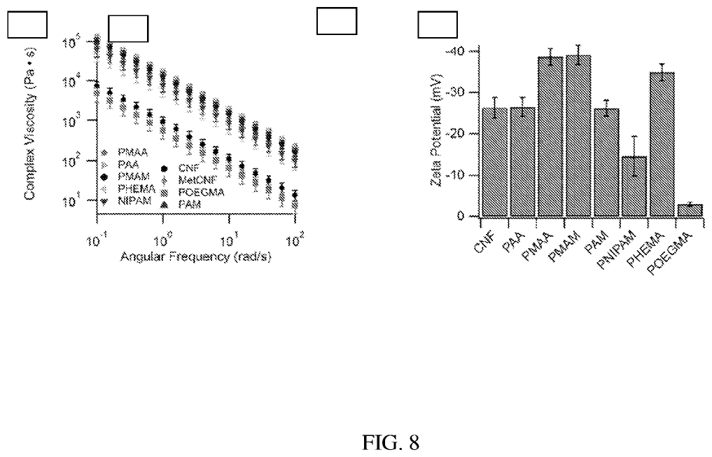

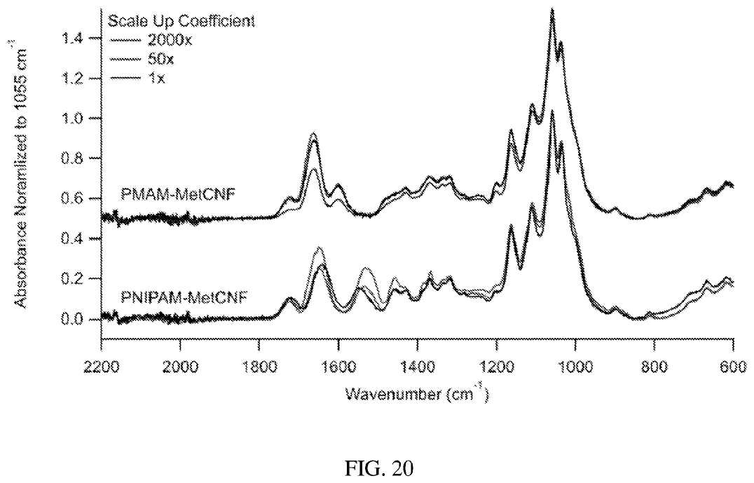

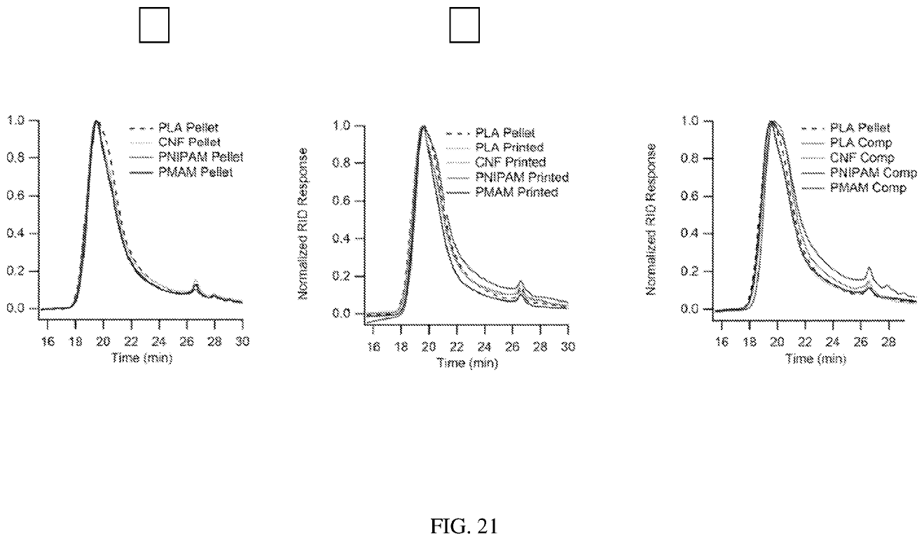

The transition from bench scale syntheses (<20 g dry) and small-scale melt mixing to kilogram scale production and 3D printing required an increase in scale at all stages of reinforcement processing. The initial synthetic scheme, shown in FIGS. 7A and 7B, was scaled from 7.5 g of solid CNFs to 300 g and was run in three batches to produce enough reinforcement for large-scale spray drying and extrusion-based 3D printing. The scaled-up syntheses produced material with lower amounts of functionalization as measured by ATR-FTIR (see FIG. 20) and quantified by previously published calibration curves. PNIPAM-MetCNF sample was calculated to be about 29%+18% PNIPAM by mass compared to about 43%+20% for the bench scale synthesis with the PMAM-MetCNF samples following a similar trend with about 10%+3% by mass PMAM at large-scale compared to about 18%+3% at bench scale. Without wishing to be bound by any particular theory, this decrease in functionalization with scale up is most likely due to changes in reaction kinetics brought on by changes in the addition rate of an initiator, which was added dropwise in the large-scale reaction. The materials were purified by water washing in the filter press until any unattached homopolymer or residual monomer was removed and then the samples were spray dried using the large-scale spray dryer.

### Small Scale Testing of Large-Scale Reinforcement

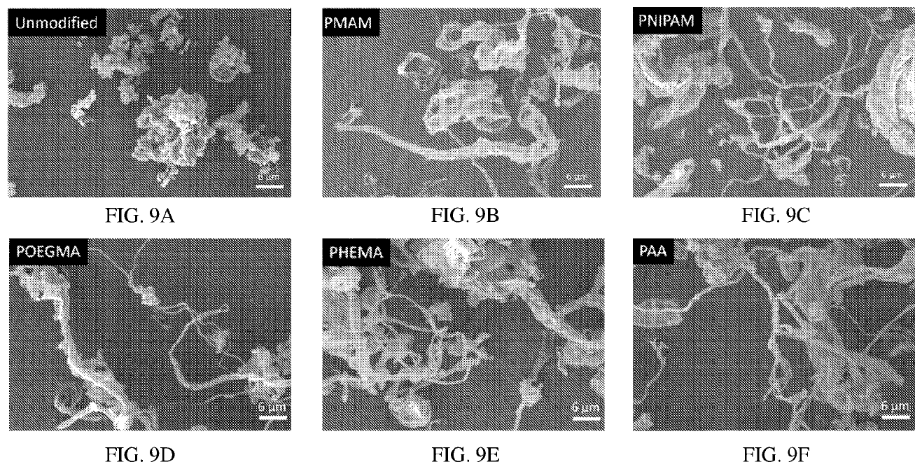

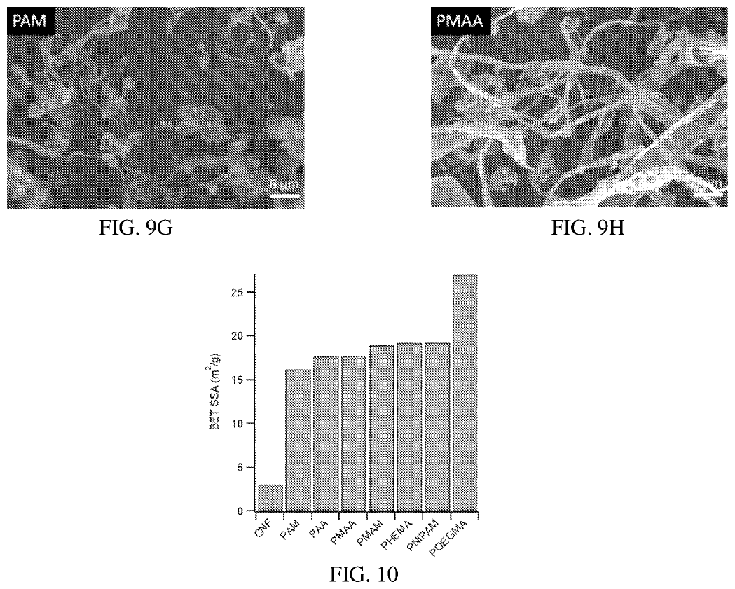

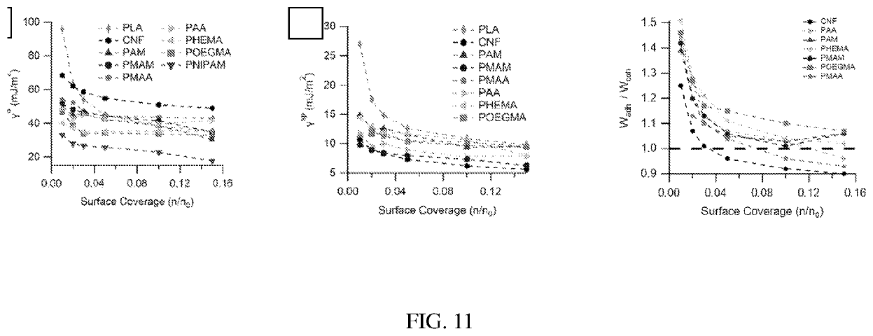

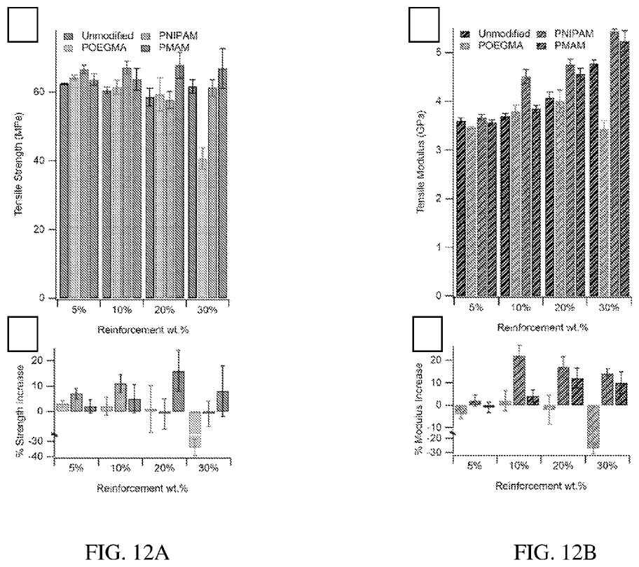

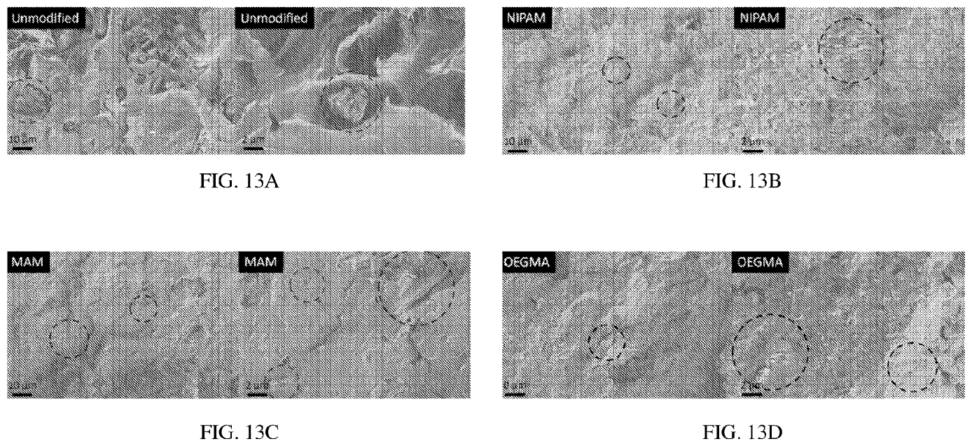

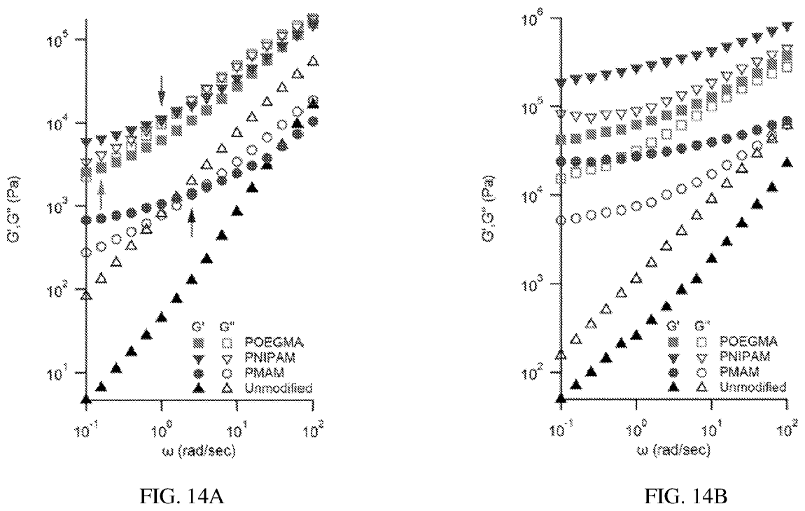

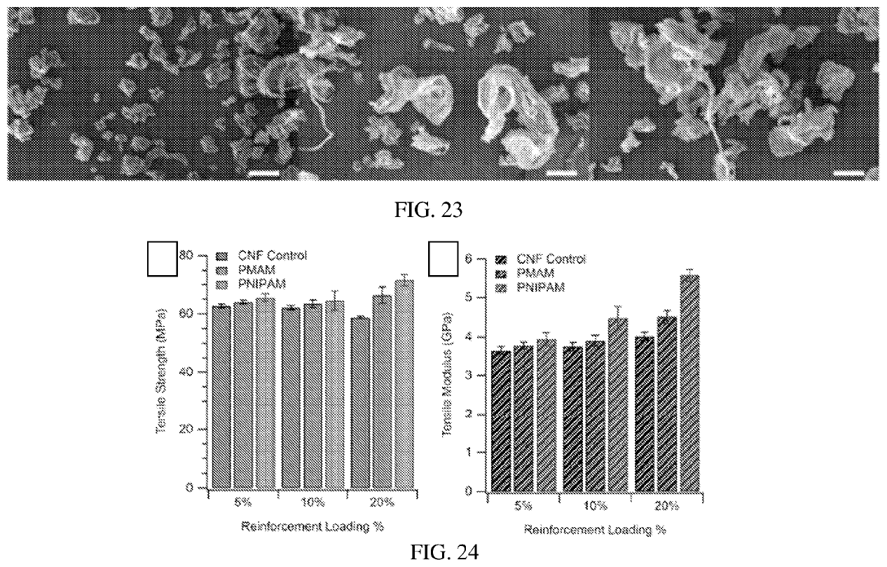

The transition from bench scale spray drying to large-scale production of the functionalized CNFs led to significant changes in particle morphology. As depicted in FIG. 23, polymer modified CNFs appeared less aggregated than the unmodified CNF control, which exhibited the dense clusters traditionally seen in these materials, but did not retain their fibrillar architecture as well as the modified materials as depicted in FIGS. 9A-9H. Without wishing to be bound by any particular theory, this morphological change may likely be a combination of multiple variations in the system including but not limited to, a lower degree of graft polymer functionalization, a higher solids content of feed suspension, changes in material transport rates, and the change to a spinning-disk atomization mechanism.

In a following experiment, an optimal loading level for subsequent additive manufacturing trials was determined for tested composites. Tensile data shown in FIG. 24 demonstrated that both the PNIPAM and PMAM modified CNFs performed better than the unmodified CNF controls at all loading levels with a dramatic improvement at a 20 wt. % loading level. At a 20 wt. % loading level, unmodified CNFs started to decrease the tensile strength of the neat PLA, presumably by introducing defect sites where stress concentrations lead to crack formation. The polymer-grafted MetCNFs (i.e. PNIPAM and PMAM modified CNFs) on the other hand continued to increase strength as a function of loading which lead to more effective reinforcement network formation. The PNIPAM-MetCNF at 20 wt. % achieved a tensile strength of about 71.5±1.9 MPa and a tensile modulus of about 5.6±0.2 GPa, an improvement of about 22% and about 39% over the corresponding CNF control, respectively, and as such was chosen as the loading level for the 3D printing study. The PMAM-MetCNF exhibited more modest improvements, with about a 13% and about a 12% improvement in strength and modulus at 20 wt. % which was also chosen for subsequent compounding and printing.

### 3D Printing and Composite Testing

With an optimal reinforcement loading of 20 wt. %, modified CNFs materials were compounded into PLA using a twin-screw extruder to produce a volume of pellets required for 3D printing on a Juggerbot system. Thermal characteristics of pellets were determined via DSC (Table 1 and Table 2) and used to pick a target extrusion temperature for 3D printing.

TABLE 1
Thermal properties of 3D printing pellets and tensile bars

| Sample | XC (%) | Tg (° C.) | Tcc (° C.) | Tm (° C.) |
|---|---|---|---|---|
| PLA Pellets | 41.5 | 54.9 | 97.6 | 145.6 |
| 20% Spray- | 1.5 | 56.8 | 99.6 | 142.9 |
| Dried(SD) | | | | |
| CNF Pellets | | | | |
| 20% PNIPAM | 2.5 | 56.0 | 99.1 | 143.3 |
| Pellets | | | | |
| 20% PMAM | 0.0 | 57.6 | 102.0 | 144.4 |
| Pellets | | | | |
| PLA Printed | 0.2 | 54.6 | 101.4 | 143.0 |
| 20% SD CNF | 0.2 | 53.0 | 87.95 | 139.7 |
| Printed | | | | |
| 20% PNIPAM | 4.0 | 58.5 | 104.1 | 145.7 |
| Printed | | | | |
| 20% PMAM | 3.7 | 54.2 | 89.7 | 147.6 |
| Printed | | | | |
| PLA Comp | 1.0 | 53.6 | 93.8 | 142.8 |
| 20% SD CNF | 2.2 | 52.3 | 86.7 | 139.3 |
| Comp | | | | |
| 20% PNIPAM | 0.0 | 53.9 | 92.6 | 141.4 |
| Comp | | | | |
| 20% PMAM | 2.7 | 51.4 | 84.10 | 138.2 |
| Comp | | | | |

Percent crystallinity (XC) of the printing pellets and printed samples obtained from the first heating cycle. Onset temperature of glass transition (Tg), cold crystallization (Tcc), and melting (Tm) obtained from the second heating cycle to be more indicative of fibril-matrix interactions.

TABLE 2
Tensile properties of 3D printed parts machined into
x-directional and z-directional tensile bars along
with compression molded anisotropic controls.

| | Tensile Strength | Tensile Modulus | Elongation at |
|---|---|---|---|
| Sample | (MPa) | (GPa) | Break (%) |
| Neat PLA X | 62 ± 1.2 | 3.4 ± 0.2 | 5.5 ± 0.7 |
| Neat PLA Z | 57.5 ± 2.6 | 3.4 ± 0.2 | 4.0 ± 0.6 |
| Neat PLA | 63.2 ± 0.7 | 3.6 ± 0.2 | 5.5 ± 0.3 |
| Compression | | | |
| Spray-Dried(SD) | 52.2 ± 2.3 | 3.9 ± 0.1 | 3.2 ± 0.3 |
| CNF 20% X | | | |
| SD CNF 20% Z | 44.5 ± 2.2 | 3.4 ± 0.2 | 3.2 ± 0.4 |
| SD CNF | 58.2 ± 0.9 | 4.0 ± 0.2 | 3.9 ± 0.2 |
| Compression | | | |
| PNIPAM 20% X | 87.9 ± 3.4 | 7.8 ± 1.6 | 2.8 ± 0.4 |
| PNIPAM 20% Z | 28.8 ± 6.2 | 5.1 ± 1.2 | 0.9 ± 0.3 |
| PNIPAM 20% | 72.4 ± 2.4 | 5.6 ± 0.2 | 2.3 ± 0.3 |
| Compression | | | |
| PMAM 20% X | 61.4 ± 3.0 | 4.5 ± 0.2 | 3.5 ± 0.3 |
| PMAM 20% Z | 47.4 ± 1.5 | 3.7 ± 0.2 | 2.9 ± 0.3 |
| PMAM 20% | 58.2 ± 0.9 | 4.0 ± 0.2 | 3.9 ± 0.2 |
| Compression | | | |

A targeted melt temperature of 165° C. was chosen as all samples exhibited peak melting temperatures below this and it represents a good balance between printability and thermal stability of the PLA.

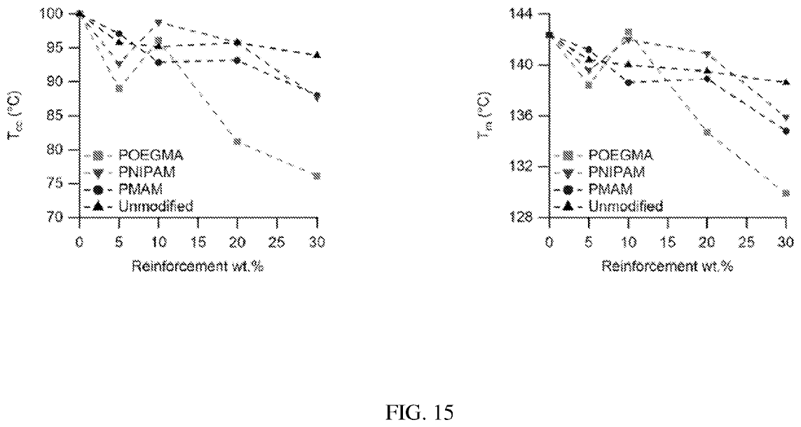

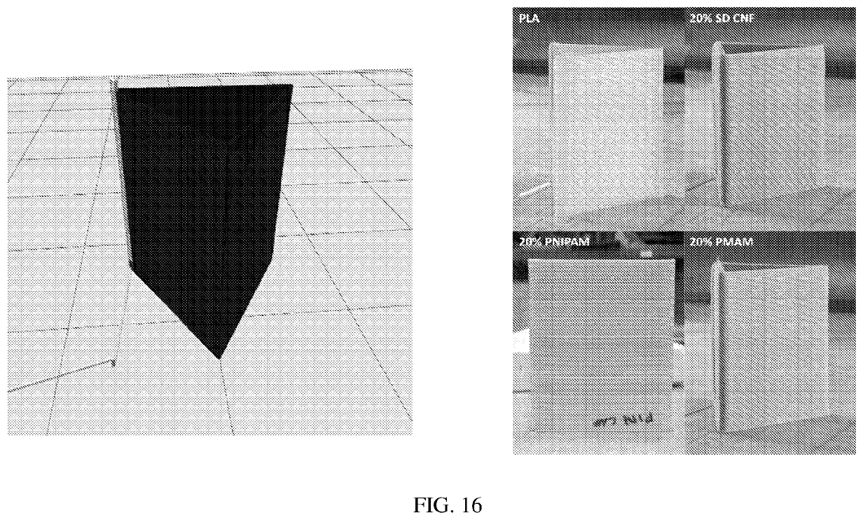

Size exclusion chromatography (SEC) analysis was conducted to verify that the PLA matrix was not degrading during processing as seen in FIG. 15. Printing parameters were optimized to produce a 6 mm wide bead and single walled triangular prisms were printed via a pellet fed FDM process. Exemplary photos of completed prints are shown in FIG. 16. These samples were then milled down to have smooth faces and cut into x-directional (parallel to the bead printing direction) and z-directional (cut perpendicular to the bead) testing samples for dynamic mechanical analysis (DMA) and tensile testing. This allowed for a comprehensive analysis of material properties in both the x direction and the z direction.

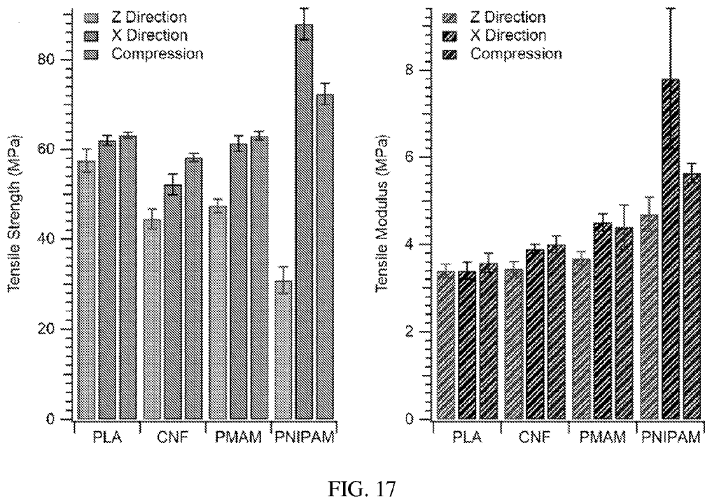

Result of tensile testing is shown in FIG. 17 where the scaled-up reinforcements are compared to neat PLA with respect to the different print directions and to isotropic compression molded samples made using the extruded pellets. Addition of spray-dried unmodified CNFs slightly decreased the tensile strength of the composite, from about 62±0.9 MPa for neat PLA to about 58.2±0.9 MPa with 20 wt. % CNF, while increasing tensile modulus from about 3.4±0.2 GPa to about 4.0±0.2 GPa. Without wishing to be bound by any particular theory, this is most likely the result of the aggregated, unmodified CNF particles retaining their morphology after melt mixing. These aggregates decrease the ultimate tensile strength of the composite by acting as stress concentration points while still increasing modulus by virtue of being a stiffer phase resisting deformation of the material.

The polymer-modified CNFs is better dispersed in the matrix, exhibiting higher moduli at the same loading level, with PNIPAM-MetCNF (about 5.6±0.2 GPa) reinforcing a composite better than PMAM-MetCNF (about 4.4±0.6 GPa) and achieving a higher ultimate tensile strength (about 72.4±2.4 MPa versus 63.1±1.0 MPa).

PNIPAM-MetCNF reinforced composite exhibited a remarkable increase in tensile strength and modulus when measured in the x-direction of the print, achieving an ultimate tensile strength of about 87.9±3.4 MPa and a tensile modulus of about 7.8±1.6 GPa. In comparison, PMAM-MetCNF sample remained relatively unchanged between compression molding and x-direction print, while the unmodified CNF control decreased in strength to about 52.2±2.3 MPa with no significant change to the modulus. PNIPAM-MetCNF reinforced PLA composite exhibits the strongest x-directional tensile strength seen to date in the literature for CNF reinforced PLA produced via 3D printing. In addition, there is a significant beneficial effect from not requiring the use of solvent casting to preserve reinforcement architecture, and employing industrially scalable drying and compounding technologies.

As shown in FIG. 17, the z-directional strength of all reinforced composites was lower than the PLA control which had relatively isotropic mechanical properties. The PNIPAM-MetCNF reinforced sample exhibited the worst z-directional strength with an ultimate tensile strength of about 28.8±6.6 MPa in comparison to the about 47.4±1.5 MPa and about 44.5±2.2 MPa measured for PMAM-MetCNF and unmodified CNF control composites, respectively. The melt temperature, layer time, and layer thickness of these reinforced samples being constant points towards an additional viscoelastic contribution to the z-directional strength.

### Viscoelastic Behavior and Fibril Alignment

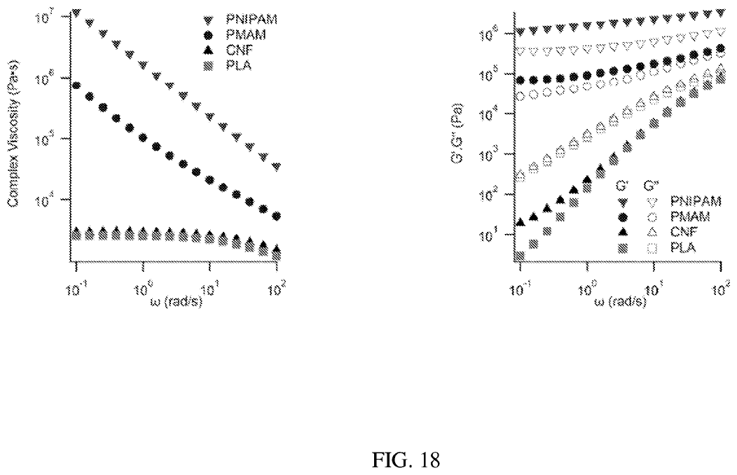

Rheological characterization of different feedstock pellets revealed large changes in complex viscosity as a function of angular frequency as seen in FIG. 18 (left). Polymer-modified CNF composites exhibited complex viscosities almost three orders of magnitude higher than neat PLA/Spray-Dried (SD) CNF control composites at the lowest angular frequencies, narrowing to an almost seven-fold increase in the case of PNIPAM-MetCNFs at the highest frequencies. Analysis of dynamic moduli, as shown in FIG. 18 (right) shows elastic-like behavior (G′>G″) at all frequencies. Unmodified SD CNF control and neat PLA both show behavior of a viscous liquid (G″>G′) at all frequencies, which indicates that the aggregated spray dried CNFs are not forming an interacting network, even at 20 wt. % loading. A lack of network formation can also be seen by presence of a complex viscosity plateau at lower frequencies, a behavior not seen in tested polymer-modified CNF composites.

Viscoelastic characterization of tested composites elucidates an underlying morphology of these materials and helps to explain tensile behavior shown in FIG. 17. PNIPAM-MetCNFs, and to a lesser extent, PMAM-MetCNFs exist as dispersed networks of fibrils, more effectively reinforcing composites than unmodified spray-dried CNFs which are acting as isolated aggregates inside of the PLA matrix.

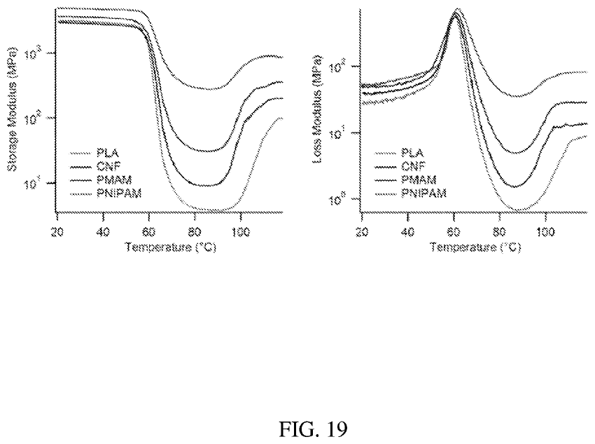

In a next experiment, directionality of reinforcements after printing a DMA study was conducted. Samples were milled from 3D printed parts in both x and z directions and pellets were compression molded to create isotropic controls. Data shown in FIG. 19 (left) compares viscoelastic response of tested printed samples in the x direction and changes in both the glassy region and the rubbery regions of the curves. PNIPAM-MetCNF sample showed the largest deviation from PLA control with about a 67% increase in the glassy storage modulus and almost three-orders of magnitude increase in the rubbery storage modulus. PMAM-MetCNF and SD CNF composites also show increases in the rubbery storage modulus but to significantly lesser extents than PNIPAM-MetCNFs most likely indicative of its better dispersion in the matrix. The loss moduli show the same trend between samples as seen in FIG. 19 (right) indicative of the samples differing abilities to reinforce composites.

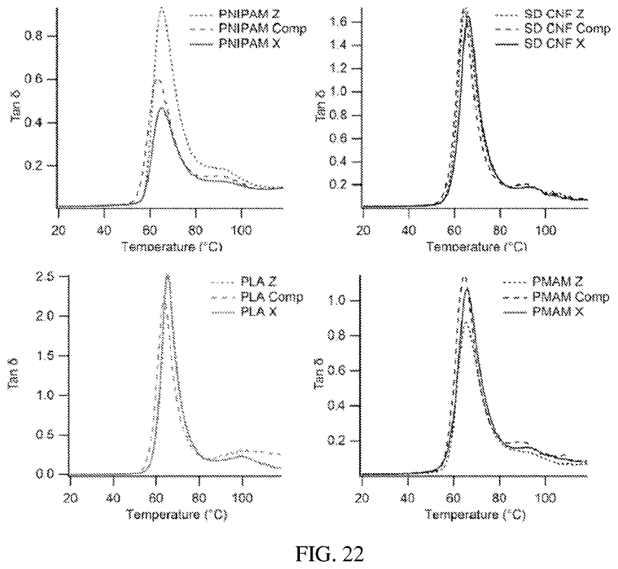

Tan delta curves in FIG. 22 provide evidence for both better dispersion and directionality of PNIPAM-MetCNF composites as compared to spray-dried CNF composites. Magnitude of tan δ, often referred to as a damping coefficient, represents a ratio of energy lost due to molecular motion versus energy stored elastically by material in a composite. Data shows that regardless of direction, PNIPAM-MetCNFs act as better reinforcements than the SD CNFs with tpeak tan δ dropping by about 46% in the z direction and by about 70% in the x direction. The explanation for this behavior is two-fold, first, the PNIPAM-MetCNFs are more well dispersed in the PLA matrix than the spray-dried CNFs, resulting in a more continuous reinforcement network which can transfer stress through the composite.

### Discussion

The present Example demonstrated industrially scalable techniques for 3D printing large scale CNF reinforced PLA composites. Large-scale syntheses of polymer functionalized CNFs were carried out in an entirely aqueous system and dried using commercial pilot scale spray drying equipment. Spray dried CNF powders were amenable to twin screw extrusion based melt mixing into PLA and printing via a pellet fed FDM approach. Printed composite tensile testing revealed that the PNIPAM modified CNF samples achieved at least about 68% improvement in x directional tensile strength over conventional spray dried CNFs reaching about 88±3 MPa, the highest recorded literature value for a 3D printed CNF/PLA composite to date.

### EQUIVALENTS

Those skilled in the art will recognize, or be able to ascertain using no more than routine experimentation, many equivalents to the specific embodiments of the invention described herein. The scope of the present invention is not intended to be limited to the above Description, but rather is as set forth in the following claims

1. A method comprising:
providing cellulosic material,
modifying at least a portion of the cellulosic material to form a modified cellulosic material comprising an acrylate ester moiety,
associating and covalently attaching to the modified cellulosic material a plurality of monomers through a water-borne polymerization at the acrylate ester moiety to form a modified cellulosic-polymer material, and
fibrillation of the modified cellulosic-polymer material to form a polymer modified cellulosic material containing fibers and fibrils.

2. The method of claim 1, wherein the cellulosic material is or comprises wood pulp, wheat straw pulp, highly refined flax fiber, agricultural waste, bagasse, bamboo, hemp, jute, cotton, kenaf, or a combination thereof.

3. The method of any of the preceding claims, wherein the cellulosic material is in aqueous suspension at the time of initiating the step of modifying the cellulosic material.

4. The method of claim 3, wherein the cellulosic material is in a reaction solution of a volume of at least about 100 liters.

5. The method of claim 4, wherein the solution is or comprises water.

6. The method of claim 4 or 5, wherein the solution is maintained at a pH.

7. The method of claim 6, wherein the pH is about 6 to 12.

8. The method of any one of claims 4-7, wherein the solution is stirred and/or mixed.

9. The method of any of the preceding claims, wherein the acrylate ester moiety is or comprises a methacrylate ester.

10. The method of any of the preceding claims, wherein the modifying is or comprises associating the cellulosic material with an acrylic anhydride.

11. The method of claim 10, wherein the associating is or comprises one or more covalent bonding events.

12. The method of claim 9 or 10, wherein the acrylic anhydride is a methacrylic anhydride.

13. The method of claim 9 or 10, wherein the acrylic anhydride is not maleic anhydride.

14. The method of any one of claims 4-12, wherein the cellulosic material and the methacrylic anhydride are in the solution at a ratio of at least about 20:1 of methacrylic anhydride moieties:cellobiose moieties and are in the presence of NaOH.

15. The method of any of the preceding claims, wherein the monomer is or comprises a radical polymerizable monomer.

16. The method of any of the preceding claims, wherein the monomer is or comprises an acrylate, an acrylic acid, an acrylamide, a styrene, a diene (e.g., butadiene, isoprene, chloroprene), acrylonitrile, a vinyl ether, or a vinyl acetate.

17. The method of claim 16, wherein the acrylate is selected from methyl methacrylate (MMA), butyl methacrylate (BMA), hexyl methacrylate (HMA), 2,2,2-trifluoroethyl methacrylate (TFEM), oligoethylene glycol methyl ether methacrylate (OEGMA), 2-hydroxyethyl methacrylate (HEMA), dimethyl 2-methylenesuccinate (DMI), methyl acrylate (MA), butyl acrylate (BA), hexyl acrylate (HA), and oligoethylene glycol methyl ether acrylate (OEGA).

18. The method of claim 16, wherein the acrylic acid is selected from acrylic acid (AA) and methacrylic acid (MAA).

19. The method of claim 16, wherein the acrylamide is selected from acrylamide (AM), N-isopropylacrylamide (NIPAM), methacrylamide (MAM), N,N-Dimethylacrylamide (DMAA), and N-[3-(Dimethylamino)propyl]methacrylamide (DMAPMA).

20. The method of claim 16, wherein the styrene is an unsubstituted styrene (Sty).

21. The method of any of the preceding claims, wherein the modified cellulosic-polymer material comprises at least one polymer selected from an acrylate ester polymer, an acrylic acid polymer, an acrylamide polymer, a styrene polymer, a diene polymer, vinyl ether polymer, and/or a vinyl acetate polymer.

22. The method of claim 21, wherein the acrylate ester polymer is selected from methyl methacrylate polymer (MMA), butyl methacrylate (BMA) polymer, hexyl methacrylate (HMA) polymer, 2,2,2-trifluoroethyl methacrylate (TFEM) polymer, oligoethylene glycol methyl ether methacrylate (OEGMA) polymer, 2-hydroxyethyl methacrylate (HEMA) polymer, dimethyl 2-methylenesuccinate (DMI) polymer, methyl acrylate (MA) polymer, butyl acrylate (BA) polymer, hexyl acrylate (HA) polymer, and oligoethylene glycol methyl ether acrylate (OEGA) polymer.

23. The method of claim 21, wherein the acrylic acid polymer is selected from acrylic acid (AA) polymer and methacrylic acid (MAA) polymer.

24. The method of claim 21, wherein the acrylamide polymer is selected from acrylamide (AM) polymer, N-isopropylacrylamide (NIPAM) polymer, methacrylamide (MAM) polymer, N,N-Dimethylacrylamide (DMAA) polymer, and N-[3-(Dimethylamino)propyl]methacrylamide (DMAPMA) polymer.

25. The method of claim 21, wherein the acrylamide polymer is selected from acrylamide (AM) polymer, N-isopropylacrylamide (NIPAM) polymer, and methacrylamide (MAM) polymer.

26. The method of claim 21, wherein the styrene polymer is an unsubstituted styrene (Sty) polymer.

27. The method of any one of claims 3-26, wherein the modified cellulosic-polymer material is in the aqueous suspension during fibrillation.

28. The method of any one of the proceeding claims, wherein the fibrillation is mechanical.

29. The method of claim 27 or 28, wherein the modified cellulosic-polymer material is fibrillated using a supermass colloider (SMC).

30. The method of any one of the preceding claims, wherein the method further comprises preparing the polymer modified cellulosic material containing fibers and fibrils for addition to a matrix polymer.

31. The method of claim 30, wherein the preparing comprises drying the polymer modified cellulosic material containing fibers and fibrils.

32. The method of claim 31, wherein the drying is spray or oven drying.

33. The method of claim 31 or 32, wherein the polymer modified cellulosic material containing fibers and fibrils is substantially dry at the time of initiating the addition to the matrix polymer.

34. The method of any one of claims 31-33, wherein the polymer modified cellulosic material containing fibers and fibrils is characterized as a reduction in fiber and/or fibril aggregation upon drying as compared to unmodified cellulose containing fibers and fibrils.

35. The method of any one of claims 31-33, wherein the polymer modified cellulosic material containing fibers and fibrils is characterized as an increase in specific surface area upon drying as compared to unmodified cellulose containing fibers and fibrils.

36. The method of any one of claims 30-35, wherein the method further comprises forming a composite by associating the polymer modified cellulosic material containing fibers and fibrils with the matrix polymer.

37. The method of claim 36, wherein the associating is or comprises compounding the polymer modified cellulosic material containing fibers and fibrils with the matrix polymer.

38. The methods of claim 36 or 37, wherein the composite is formed through melt mixing and/or solution mixing.

39. The methods of any one of claims 36-38, wherein the composite is processed via extrusion, compression molding, injection molding, and/or fused layer modeling process.

40. The method of any one of claims 30-39, wherein the matrix polymer is a thermoplastic.

41. The method of claim 40, wherein the thermoplastic is or comprises acrylonitrile butadiene styrene (ABS), polyethylene terephthalate glycol modified (PETG), poly(latic acid) (PLA), polypropylene (PP), polybutylene terephthalate (PBT), and/or high density polyethylene (HDPE).

42. The method of claim 40, wherein the matrix polymer is or comprises poly(latic acid) (PLA).

43. The method of any one of claims 36-42, wherein the amount of polymer modified cellulosic material containing fibers and fibrils in the composite is between 0.5% and 50% by weight of the composite.

44. A method comprising:
providing cellulosic material,
modifying at least a portion of the cellulosic material to form a modified cellulosic material comprising an acrylate ester moiety,
fibrillation of the modified cellulosic material comprising an acrylate ester moiety to form a modified cellulosic material containing fibers and fibrils, and
associating and covalently attaching to the modified cellulosic material containing fibers and fibrils a plurality of monomers through a water-borne polymerization at the acrylate ester moiety to form a polymer modified cellulosic material containing fibers and fibrils.

45. The method of claim 44, wherein the cellulosic material is or comprises wood pulp, wheat straw pulp, highly refined flax fiber, agricultural waste, bagasse, bamboo, hemp, jute, cotton, kenaf, or a combination thereof.

46. The method of claim 44 or 45, wherein the cellulosic material is in aqueous suspension at the time of initiating the step of modifying the cellulosic material.

47. The method of claim 46, wherein the cellulosic material is in a reaction solution of a volume of at least about 100 liters.

48. The method of claim 47, wherein the solution is or comprises water.

49. The method of claim 47 or 48, wherein the solution is maintained at a pH.

50. The method of claim 49, wherein the pH is about 6 to 12.

51. The method of any one of claims 47-50, wherein the solution is stirred and/or mixed.

52. The method of any of claims 44-51, wherein the acrylate ester moiety is or comprises a methacrylate ester.

53. The method of any of claims 44-52, wherein the modifying is or comprises associating the cellulosic material with an acrylic anhydride.

54. The method of claim 53, wherein the associating is or comprises one or more covalent bonding events.

55. The method of claim 53 or 54, wherein the acrylic anhydride is a methacrylic anhydride.

56. The method of claim 53 or 54, wherein the acrylic anhydride is not maleic anhydride.

57. The method of any one of claims 47-56, wherein the cellulosic material and the methacrylic anhydride are in the solution at a ratio of at least about 20:1 of methacrylic anhydride moieties:cellobiose moieties and are in the presence of NaOH.

58. The method of any one of claims 46-57, wherein the modified cellulosic material comprising an acrylate ester moiety is in the aqueous suspension during fibrillation.

59. The method of any one of claims 44-58, wherein the fibrillation is mechanical.

60. The method of claim 58 or 59, wherein the modified cellulosic material comprising an acrylate ester moiety is fibrillated using a supermass colloider (SMC).

61. The method of any of claims 44-60, wherein the monomer is or comprises a radical polymerizable monomer.

62. The method of any of claims 44-61, wherein the monomer is or comprises an acrylate, an acrylic acid, an acrylamide, a styrene, a diene (e.g., butadiene, isoprene, chloroprene), acrylonitrile, a vinyl ether, or a vinyl acetate.

63. The method of claim 62, wherein the acrylate is selected from methyl methacrylate (MMA), butyl methacrylate (BMA), hexyl methacrylate (HMA), 2,2,2-trifluoroethyl methacrylate (TFEM), oligoethylene glycol methyl ether methacrylate (OEGMA), 2-hydroxyethyl methacrylate (HEMA), dimethyl 2-methylenesuccinate (DMI), methyl acrylate (MA), butyl acrylate (BA), hexyl acrylate (HA), and oligoethylene glycol methyl ether acrylate (OEGA).

64. The method of claim 62, wherein the acrylic acid is selected from acrylic acid (AA) and methacrylic acid (MAA).

65. The method of claim 62, wherein the acrylamide is selected from acrylamide (AM), N-isopropylacrylamide (NIPAM), methacrylamide (MAM), N,N-Dimethylacrylamide (DMAA), and N-[3-(Dimethylamino)propyl]methacrylamide (DMAPMA).

66. The method of claim 62, wherein the styrene is an unsubstituted styrene (Sty).

67. The method of any of claims 44-66, wherein the polymer modified cellulosic material containing fibers and fibrils comprises at least one polymer selected from an acrylate ester polymer, an acrylic acid polymer, an acrylamide polymer, a styrene polymer, a diene polymer, vinyl ether polymer, and/or a vinyl acetate polymer.

68. The method of claim 67, wherein the acrylate ester polymer is selected from methyl methacrylate polymer (MMA), butyl methacrylate (BMA) polymer, hexyl methacrylate (HMA) polymer, 2,2,2-trifluoroethyl methacrylate (TFEM) polymer, oligoethylene glycol methyl ether methacrylate (OEGMA) polymer, 2-hydroxyethyl methacrylate (HEMA) polymer, dimethyl 2-methylenesuccinate (DMI) polymer, methyl acrylate (MA) polymer, butyl acrylate (BA) polymer, hexyl acrylate (HA) polymer, and oligoethylene glycol methyl ether acrylate (OEGA) polymer.

69. The method of claim 67, wherein the acrylic acid polymer is selected from acrylic acid (AA) polymer and methacrylic acid (MAA) polymer.

70. The method of claim 67, wherein the acrylamide polymer is selected from acrylamide (AM) polymer, N-isopropylacrylamide (NIPAM) polymer, methacrylamide (MAM) polymer, N,N-Dimethylacrylamide (DMAA) polymer, and N-[3-(Dimethylamino)propyl]methacrylamide (DMAPMA) polymer.

71. The method of claim 67, wherein the acrylamide polymer is selected from acrylamide (AM) polymer, N-isopropylacrylamide (NIPAM) polymer, and methacrylamide (MAM) polymer.

72. The method of claim 67, wherein the styrene polymer is an unsubstituted styrene (Sty) polymer.

73. The method of any one of claims 44-72, wherein the method further comprises preparing the polymer modified cellulosic material containing fibers and fibrils for addition to a matrix polymer.

74. The method of claim 73, wherein the preparing comprises drying the polymer modified cellulosic material containing fibers and fibrils.

75. The method of claim 74, wherein the drying is spray or oven drying.

76. The method of claim 74 or 75, wherein the polymer modified cellulosic material containing fibers and fibrils is substantially dry at the time of initiating the addition to the matrix polymer.

77. The method of any one of claims 74-76, wherein the polymer modified cellulosic material containing fibers and fibrils is characterized as a reduction in fiber and/or fibril aggregation upon drying as compared to unmodified cellulosic material containing fibers and fibrils.

78. The method of any one of claims 74-76, wherein the polymer modified cellulosic material containing fibers and fibrils is characterized as an increase in specific surface area upon drying as compared to unmodified cellulosic material containing fibers and fibrils.

78. The method of any one of claims 73-78, wherein the method further comprises forming a composite by associating the polymer modified cellulosic material containing fibers and fibrils with the matrix polymer.

79. The method of claim 78, wherein the associating is or comprises compounding the polymer modified cellulosic material containing fibers and fibrils with the matrix polymer.

80. The methods of claim 78 or 79, wherein the composite is formed through melt mixing and/or solution mixing.

81. The methods of any one of claims 78-80, wherein the composite is processed via extrusion, compression molding, injection molding, and/or fused layer modeling process.

82. The method of any one of claims 73-81, wherein the matrix polymer is a thermoplastic.

83. The method of claim 82, wherein the thermoplastic is or comprises acrylonitrile butadiene styrene (ABS), polyethylene terephthalate glycol modified (PETG), poly(latic acid) (PLA), polypropylene (PP), polybutylene terephthalate (PBT), and/or high density polyethylene (HDPE).

84. The method of claim 82, wherein the matrix polymer is or comprises poly(latic acid) (PLA).

85. The method of any one of claims 78-85, wherein the amount of polymer modified cellulosic material containing fibers and fibrils in the composite is between 0.5% and 50% by weight of the composite.

86. A method comprising:
providing a cellulose containing fibers and fibrils,
modifying at least a portion of the cellulose containing fibers and fibrils in water to form a modified cellulose comprising an acrylate ester moiety, and
associating and covalently attaching to the modified cellulose a plurality of monomers through a water-borne polymerization at the acrylate ester moiety to form a polymer modified cellulose material containing fibers and fibrils.

87. The method of claim 86, wherein the acrylate ester moiety is or comprises a methacrylate ester.

88. The method of claim 86 or 87, wherein the modifying is or comprises associating the cellulose containing fibers and fibrils with an acrylic anhydride.

89. The method of claim 88, wherein associating is or comprises one or more covalent bonding events.

90. The method of claim 88 or 89, wherein the acrylic anhydride is a methacrylic anhydride.

91. The method of claim 88 or 89, wherein the acrylic anhydride is not maleic anhydride.

92. The method of any of claims 86-91, wherein the cellulose containing fibers and fibrils is in suspension at the time of initiating the step of modifying the cellulose material.

93. The method of claim 92, wherein the cellulose containing fibers and fibrils is in a reaction solution of a volume of at least about 100 liters.

94. The method of claim 93, wherein the solution is or comprises water.

95. The method of claim 93 or 94, wherein the solution is maintained at a pH.

96. The method of claim 95, wherein the pH is about 6 to 12.

97. The method of any one of claims 93-96, wherein the solution is stirred and/or mixed.

98. The method of any one of claims 86-97, wherein the monomer is or comprises a radical polymerizable monomer.

99. The method of any of claims 86-98, wherein the monomer is or comprises an acrylate, an acrylic acid, an acrylamide, a styrene, a diene (e.g., butadiene, isoprene, chloroprene), acrylonitrile, a vinyl ether, or a vinyl acetate.

100. The method of claim 99, wherein the acrylate is selected from methyl methacrylate (MMA), butyl methacrylate (BMA), hexyl methacrylate (HMA), 2,2,2-trifluoroethyl methacrylate (TFEM), oligoethylene glycol methyl ether methacrylate (OEGMA), 2-hydroxyethyl methacrylate (HEMA), dimethyl 2-methylenesuccinate (DMI) polymer, methyl acrylate (MA), butyl acrylate (BA), hexyl acrylate (HA, and oligoethylene glycol methyl ether acrylate (OEGA).

101. The method of claim 99, wherein the acrylic acid is selected from acrylic acid (AA) and methacrylic acid (MAA).

102. The method of claim 99, wherein the acrylamide is selected from acrylamide (AM), N-isopropylacrylamide (NIPAM), and methacrylamide (MAM), N,N-Dimethylacrylamide (DMAA), and N-[3-(Dimethylamino)propyl]methacrylamide (DMAPMA).

103. The method of claim 99, wherein the styrene is an unsubstituted styrene (Sty).

104. The method of any of claims 86-103, wherein the polymer modified cellulose material containing fibers and fibrils comprises at least one polymer selected from an acrylate ester polymer, an acrylic acid polymer, an acrylamide polymer, a styrene polymer, a diene polymer, vinyl ether polymer, and/or a vinyl acetate polymer.

105. The method of claim 104, wherein the acrylate ester polymer is selected from methyl methacrylate polymer (MMA), butyl methacrylate (BMA) polymer, hexyl methacrylate (HMA) polymer, 2,2,2-trifluoroethyl methacrylate (TFEM) polymer, oligoethylene glycol methyl ether methacrylate (OEGMA) polymer, 2-hydroxyethyl methacrylate (HEMA) polymer, dimethyl 2-methylenesuccinate (DMI) polymer, methyl acrylate (MA) polymer, butyl acrylate (BA) polymer, hexyl acrylate (HA) polymer, and oligoethylene glycol methyl ether acrylate (OEGA) polymer.

106. The method of claim 104, wherein the acrylic acid polymer is selected from acrylic acid (AA) polymer and methacrylic acid (MAA) polymer.

107. The method of claim 104, wherein the acrylamide polymer is selected from acrylamide (AM) polymer, N-isopropylacrylamide (NIPAM) polymer, methacrylamide (MAM) polymer, N,N-Dimethylacrylamide (DMAA) polymer, and N-[3-(Dimethylamino)propyl]methacrylamide (DMAPMA) polymer.

108. The method of claim 104, wherein the styrene polymer is an unsubstituted styrene polymer (Sty).

109. The method of any one of claims 86-108, wherein the method further comprises preparing the polymer modified cellulose material containing fibers and fibrils for addition to a matrix polymer.

110. The method of claim 109, wherein the preparing comprises drying the polymer modified cellulose material containing fibers and fibrils.

111. The method of claim 110, wherein the drying is spray or oven drying.

112. The method of claim 110 or 111, wherein the polymer modified cellulose material containing fibers and fibrils is substantially dry at the time of initiating the addition to the matrix polymer.

113. The method of any one of claims 110-112, wherein the polymer modified cellulose material containing fibers and fibrils is characterized as a reduction in fiber and/or fibril aggregation upon drying as compared to unmodified cellulose material containing fibers and fibrils.

114. The method of any one of claims 110-112, wherein the polymer modified cellulose material containing fibers and fibrils is characterized as an increase in specific surface area upon drying as compared to unmodified cellulose material containing fibers and fibrils.

115. The method of any one of claims 109-114, wherein the method further comprises forming a composite by associating the polymer modified cellulose material containing fibers and fibrils with the matrix polymer.

116. The method of claim 115, wherein the associating is or comprises compounding the polymer modified cellulose material containing fibers and fibrils with the matrix polymer.

117. The methods of claim 115 or 116, wherein the composite is formed through melt mixing and/or solution mixing.

118. The methods of any one of claims 115-116, wherein the composite is processed via extrusion, compression molding, injection molding, and/or fused layer modeling process.

119. The method of any one of claims 109-118, wherein the matrix polymer is a thermoplastic.

120. The method of claim 119, wherein the thermoplastic is or comprises acrylonitrile butadiene styrene (ABS), polyethylene terephthalate glycol modified (PETG), poly(latic acid) (PLA), polypropylene (PP), polybutylene terephthalate (PBT), and/or high density polyethylene (HDPE).

121. The method of claim 119, wherein the matrix polymer is or comprises poly(latic acid) (PLA).

122. The method of any one of claims 115-121, wherein the amount of polymer modified cellulose material containing fibers and fibrils in the composite is between 0.5% and 50% by weight of the composite.

123. A composite material produced according to the method of any one of the above claims.

124. A composite for 3D-Printing produced according to the method of any one of claims 1-122.

125. An improved composite for 3D-Printing produced according to the method of any one of claims 1-122.

126. A biodegradable composite produced according to the method of any one of claims 1-122.
